(19) United States
(12) Patent Application Publication
(10) Pub. No.: US 2015/0278195 A1
(43) Pub. Date: Oct. 1, 2015

(54) TEXT DATA SENTIMENT ANALYSIS METHOD

(71) Applicant: ABBYY InfoPoisk LLC, Moscow (RU)

(72) Inventors: David Yevgenievich Yang, Moscow (RU); Anton Yevgenievich Tyurin, Moscow (RU); Maksim Borisovich Mikhaylov, Moscow (RU); Tatiana Vladimirovna Danielyan, Moscow (RU); Olga Vladimirovna Lokotilova, Sverdlovsk (RU)

(21) Appl. No.: 14/509,311

(22) Filed: Oct. 8, 2014

(30) Foreign Application Priority Data
Mar. 31, 2014 (RU) 2014112242

(51) Int. Cl. G06F 17/27

(52) U.S. Cl. CPC G06F 17/2785

(57) ABSTRACT

A method and system for text data analysis by performing deep syntactic and semantic analysis of text data and extracting entities and facts from the text data based on the results of deep syntactic and semantic analysis, including extraction of sentiments using a sentiment lexicon constructed upon a semantic hierarchy. The data analysis can include determining sign of the extracted sentiment, aggregate function of the text data, analyzing social mood, and classifying the text data.

### CROSS REFERENCE TO RELATED APPLICATIONS

This application claims the benefit of priority under 35 USC 119 to Russian Patent Application No. 2014112242, filed Mar. 31, 2014; the disclosure of which is incorporated herein by reference.

### TECHNICAL FIELD

This invention relates to a device, a system, a method, and a software application for automatically determining meanings in a natural language. More specifically, it relates to natural language processing methods and systems, including processing of texts and large text corpora. One aim of the invention is to analyze textual information for further sentiment analysis.

### BACKGROUND

Presently, problems of applied linguistics such as semantic analysis, fact extraction and sentiment analysis are especially popular due to the development of modem technologies. Moreover, there is a rapidly growing demand for technological products capable of high-quality text processing and of presenting the results in a simple, convenient form.

One possible source of text data are messages of different types in social networks, forums, e-mail, etc. Fact extraction from text data is one of the most pressing challenges of the contemporary world. The ability to analyze text data at a level of being able to understand the meaning embedded in the text opens up many opportunities, from studying the users' opinion about a recently released movie to developing financial market forecasts.

Today, many companies are faced with the problem of efficient HR management due to the lack of objective information on the prevalent mood in the company, the staffs emotional condition and state of mind, the problems that employees are most concerned about now and the topics they discuss most. Entire company units are tasked with supporting a healthy corporate spirit, yet even these specialized units are incapable of providing an unbiased evaluation of a company climate or understanding the benefit or need of their actions, the consequences of those actions and their expediency in the future. It may not always be possible to identify employees' wishes for arranging comfortable work conditions, conflict-free collaboration among different business units, and etc.

One proposed method for efficient company management is a tool that may be useful to senior company managers as well as HR departments. This tool is aimed at analyzing text data contained in corporate forums and other means of textual communication among employees (such as corporate mail).

The aim of text analysis (such as messages) is to identify leaders within the company, to measure the temperature both in the whole company and in each of its units, to disclose social networks between colleagues and units, to identify pressing issues for staff and popular topics for discussion, etc. Text data analysis relies on applied linguistics techniques, especially semantic analysis based on semantic hierarchy, sentiment analysis, fact extraction, etc.

The invention is useful for enhancing a company's performance by way of analyzing the staffs mood. It can also be applied to make forecasts for events being organized and to analyze actions that were taken. It enables greater flexibility in company management by providing a more complete understanding of the employees.

Sentiment analysis (SA) may be performed at one of the following levels: sentence level SA, document level SA, as well as the entity and aspect level—in other words, directed SA.

Sentence level sentiment analysis (SA) is used to determine the opinion or sentiment expressed by a sentence as a whole: negative, positive, or neutral. Sentence level SA is based on the linguistic approach, which does not require a large collection of tagged text corpora for in-depth study, but rather uses emotionally colored sentiment lexicon. There are many ways to create sentiment lexicon, but they all require human participation. This makes the linguistic approach quite resource consuming, rendering it virtually impractical in its pure form.

Document level sentiment analysis (SA) uses the statistical approach. There are several advantages to this approach and it is not very labor consuming. However, the statistical approach requires a large collection of tagged training texts to be used as a base. At the same time, the collection of training texts must be sufficiently representative, or in other words, it must contain a lexicon that is large and sufficient enough to train a classifier in various domains. After applying a trained classifier to an untagged text, the source document (text message) will be generally classified as expressing a negative or positive opinion or sentiment. The number of classes may differ from the above example. For example, the classes may be extended to include very negative or very positive opinions, and etc.

None of the above-mentioned levels of sentiment analysis (namely, sentence level SA and document level SA) is able to identify the sentiment on the local level, i.e., to extract facts on specific entities, their aspects and the emotional coloring in textual data.

Sentence or document level sentiment analysis (SA) methods generalize the available information, which ultimately results in loss of data.

The presented invention relies on entity and aspect level sentiment analysis (SA), or in other words, directed text data SA. An advantage of the directed (aspect and entity level) SA is that it is able to identify not only the sentiment (positive, negative, etc.), but also the Object of Sentiment and Target of Sentiment.

### DISCLOSURE OF THE INVENTION

One aspect of this invention concerns the method of text data analysis. The method is comprised of the following: acquiring, by a computer, text data, performing deep syntactic and semantic analysis of the acquired text data, and extracting entities and facts from the text data based on the results of deep syntactic and semantic analysis, which includes sentiment extraction using sentiment lexicon based upon a semantic hierarchy. The method further includes determining the sign of the extracted sentiments. Additionally, it includes determining the general sentiment of the text data. The method yet includes identifying social networks based on the extracted entities and facts. The method also includes identifying topics based on the extracted entities and facts. The method further includes analyzing the social mood based on the extracted sentiments. The method also includes classifying text data based on the extracted sentiments.

### BRIEF DESCRIPTION OF DRAWINGS

Additional aims, characteristics and advantages of the invention will be apparent from the following description of the present invention with reference to the accompanying drawings, where:

FIG. 1 illustrates an exemplary flow chart demonstrating the steps sequence according to one of the embodiments of this invention;

FIG. 2 illustrates an exemplary lexical structure for the sentence “This child is smart, he'll do well in life”;

FIG. 3 illustrates the steps sequence of deep analysis according to one of the embodiments of this invention;

FIG. 4 illustrates the scheme of the step including a rough syntactic analyzer according to one of the embodiments of this invention;

FIG. 5 illustrates syntactic descriptions according to one of the embodiments of this invention;

FIG. 6 is a detailed illustration of the rough syntactic analysis process according to one of the embodiments of this invention;

FIG. 7 illustrates an exemplary generalized component graph for the sentence “This child is smart, he'll do well in life” according to one of the embodiments of this invention;

FIG. 8 illustrates an accurate syntactic analysis according to one of the embodiments of this invention;

FIG. 9 illustrates an exemplary syntactic tree according to one of the embodiments of this invention;

FIG. 10 illustrates a scheme of a sentence analysis method according to one of the embodiments of this invention;

FIG. 11 illustrates a scheme demonstrating linguistic descriptions according to one of the embodiments of this invention;

FIG. 12 illustrates exemplary morphological descriptions according to one of the embodiments of this invention;

FIG. 13 illustrates semantic descriptions according to one of the embodiments of this invention;

FIG. 14 illustrates a scheme demonstrating lexical descriptions according to one of the embodiments of this invention;

FIG. 15 illustrates a semantic structure scheme obtained by analyzing the sentence “ [symbol] [symbol] [symbol] [symbol] [symbol] [symbol] ” (“Moscow is a rich and beautiful city as all proper capitals”) according to one of the embodiments of this invention;

FIG. 16 illustrates a model that may be selected to determine the sentiment of text data according to one of the embodiments of this invention;

FIG. 17 illustrates an exemplary information RDF graph for an exemplary parsing of the sentence “ [symbol] [symbol] [symbol] [symbol] [symbol] [symbol] ” (“Moscow is a rich and beautiful city as all proper capitals”) according to one of the embodiments of this invention;

FIG. 18 illustrates an exemplary completed tree-like structure according to one of the embodiments of this invention;

FIG. 19 illustrates an exemplary hardware scheme according to one of the embodiments of this invention.

### DESCRIPTION OF PREFERRED EMBODIMENTS

The invention represents a method that includes an instruction for a device, an operating system, and hardware-and-software providing a solution to the problem of text data (message) sentiment analysis based on combining the statistical and linguistic approaches.

This invention is designed for sentiment analysis of text data (messages). The method relies on two-stage syntactic analysis based on the comprehensive linguistic descriptions represented in U.S. Pat. No. 8,078,450.

Since, according to the invention, the method of text data (message) analysis is based on the use of language-independent semantic units, the invention is also language-independent and enables operations with one or several natural languages. In other words, the invention is capable of sentiment analysis (SA) for multiple-language texts as well.

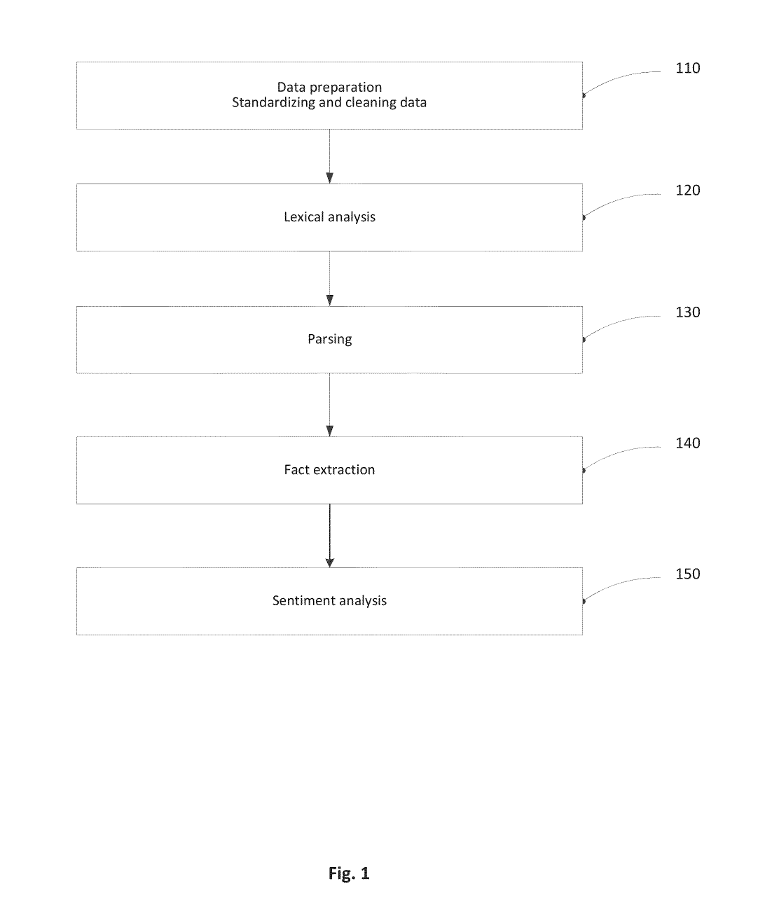

FIG. 1 illustrates an exemplary flow chart demonstrating the steps sequence according to one of the embodiments of this invention.

### Data Preparation Step

At step 110, text data (for example, messages) such as e-mails or forum posts may be preliminary prepared for analysis. First, they may be standardized and uniformly structured. Namely, a sequence of text data (such as e-mails or forum posts) may be split up into uniform, integral text messages. If correspondence in a forum or via e-mail includes messages containing a correspondence history which is automatically copied in the reply mail, the messages will be duplicated in the data base. Such instances of duplication may interfere with further analysis. One of the criteria indicating that a message does not contain the correspondence history in the thread is the presence of the same mailing date.

After splitting up text data (such as messages) into integral independent units, the data is then cleaned. At this step, duplicate messages are eliminated. Duplicate messages often appear in the mail thread or as a quotation (for example, in forums).

### Lexical Analysis

Lexical analysis of sentences must be carried out before text data (messages) can be analyzed.

Lexical analysis is performed with the source sentence in the source language. The source language can be any natural language with all the necessary linguistic descriptions created. For example, a source sentence may be split up into a number of lexemes (lexical units) or elements that include all the words, dictionary forms, spaces, punctuators and etc. in the source sentence for making the lexical structure of the sentence. A lexeme (lexical unit) is a meaningful linguistic unit that is a dictionary item, such as the lexical description of a language.

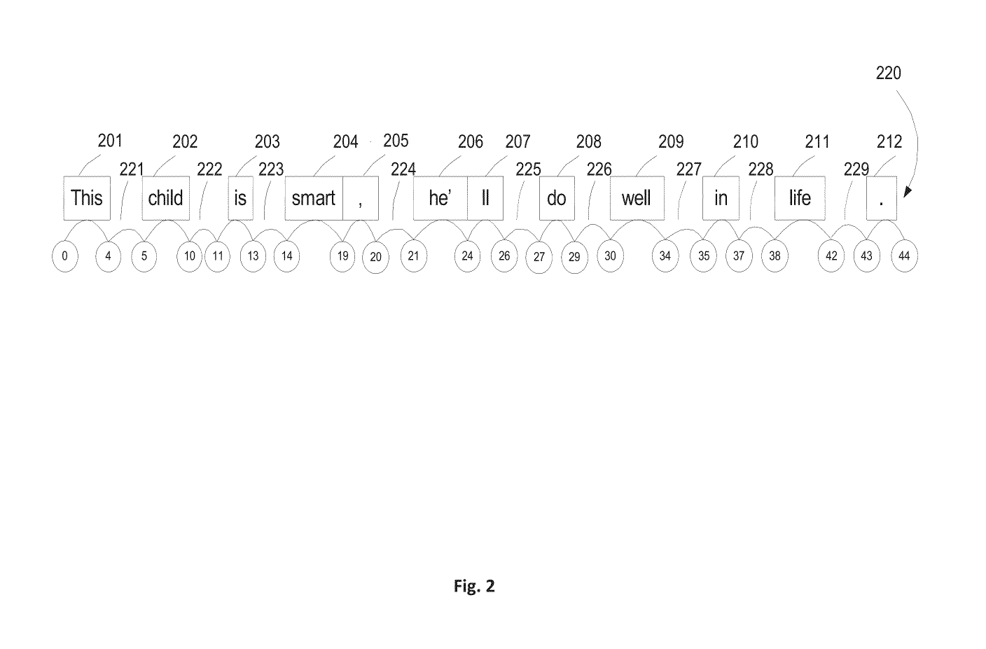

FIG. 2. illustrates an exemplary lexical structure of the sentence 220 “This child is smart, he'll do well in life” in English, where all of the words and punctuators are represented by twelve (12) elements 201-212 or entities, and by nine (9) spaces 221-229. Spaces 221-229 may be represented by one or more punctuators, gaps, etc.

A graph of lexical structure is constructed based on elements 201-212 of the sentence. Graph nodes are the coordinates of the starting and ending characters of entities, while graph arcs are words, intervals between entities 201-212 (dictionary forms and punctuators), or punctuators. For example, in FIG. 2, graph nodes are presented as coordinates: 0, 4, 5 . . . .

Outgoing and incoming arcs are depicted for each coordinate. The arcs can be created for the respective entities 201-212, as well as for intervals 221-229. The lexical structure of the sentence 220 can be used later for rough syntactic analysis 330.

### Sentiment Analysis

The prepared text data base (for instance, a base of messages) undergoes sentiment analysis. Sentiment analysis is currently one of the most rapidly developing domains of natural language processing. It is aimed at detecting the text's sentiment or the author's opinions (attitudes) with regard to the described object (person, item, topic, etc.) based on an emotionally colored (sentiment) lexicon.

The sentiment analysis according to this invention is based on a linguistic approach that relies on the Universal Semantic Hierarchy (SH), which is thoroughly described in U.S. Pat. No. 8,078,450, and more specifically, on the rule-based approach of syntactic and semantic analysis.

The presented invention relies on entity and aspect level sentiment analysis (SA), or in other words, directed text data sentiment analysis (SA). A sentiment object is an appraised object (entity) mentioned in the text, i.e., a sentiment carrier. A subject is an opinion/sentiment holder. The holder may be explicitly mentioned in the text, although often there may be no information on the holder, significantly complicating the issue.

The described sentiment analysis method relies on the sentiment lexicon approach and the rule-based approach.

This invention involves the detection of explicit sentiments.

The invention enables the local sentiment in text data (for example, in messages) to be detected and the sentiment sign to be determined using a two-point scale, such as a positive or negative sentiment. The type of scale representing one of the embodiments is introduced for illustration purposes and shall not limit the scope of the invention.

This invention adapts the statistical and linguistic approaches to the sentiment identification using the results of semantic and syntactic analyzer operations as source data. ABBYY Compreno is an example of a useful semantic and syntactic analyzer.

U.S. Pat. No. 8,078,450 describes a method that includes deep syntactic and semantic analysis of texts in a natural language based on comprehensive linguistic descriptions. This technology may be used for the sentiment analysis (SA) of a natural language text. The method uses a broad range of linguistic descriptions and semantic mechanisms, both universal and language-specific, allowing all of the language complexities to be expressed without simplification and artificial restrictions, and avoiding a combinatorial explosion or uncontrolled increase of complexity. In addition, the described analytical methods follow the principle of integral and targeted recognition, i.e., hypotheses about the structure of a part of a sentence are verified in the process of verifying the hypothesis about the structure of the entire sentence. This approach avoids the analysis of a large number of anomalies and variants.

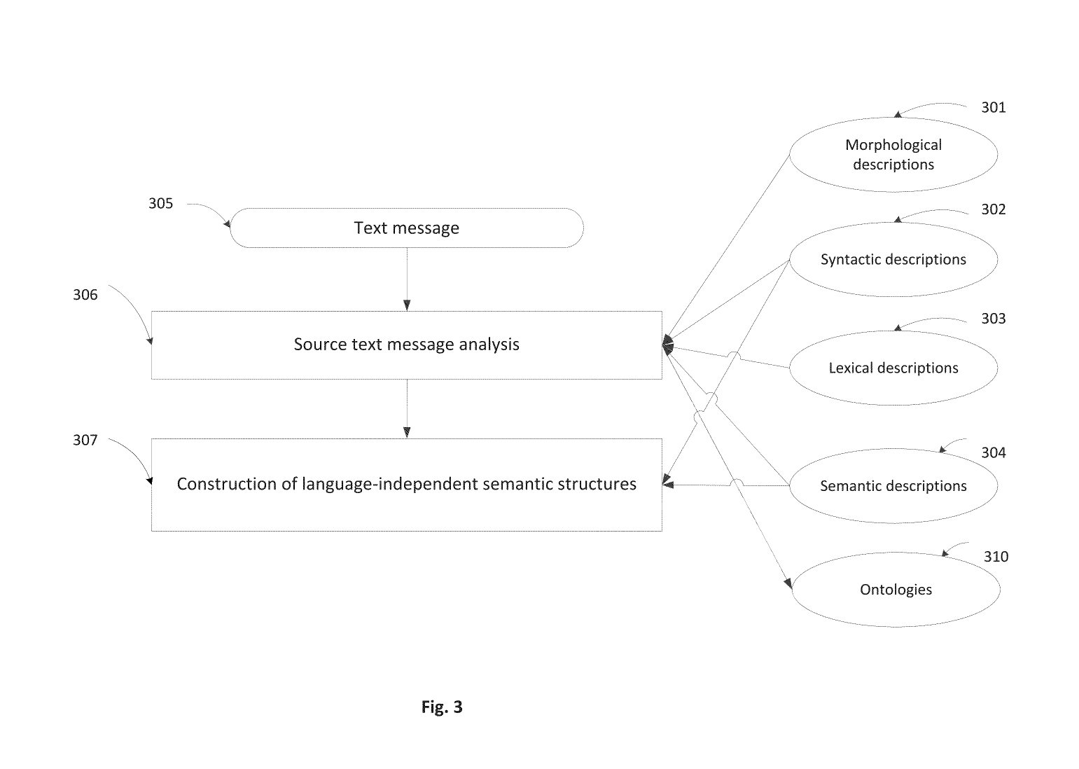

Deep analysis includes lexical-morphological, syntactic and semantic analysis of each sentence of a text corpus, resulting in the construction of language-independent semantic structures where each word of the text matches a corresponding semantic class. FIG. 3 illustrates a complete scheme of the deep text analysis method. The text 305 undergoes comprehensive syntactic and semantic analysis 306 using linguistic descriptions of the source language and universal semantic descriptions, enabling analysis of not only the surface syntactic structure, but also the deep, semantic structure which expresses the meanings of statements in each sentence, as well as the links between the sentences or parts of the text. Linguistic descriptions may include lexical descriptions 303, morphological descriptions 301, syntactic descriptions 302, and semantic descriptions 304. The analysis 306 includes a syntactic analysis implemented as a two-step algorithm (rough syntactic analysis and precise syntactic analysis) using linguistic models and information of different levels to calculate theoretical frequency and generate a plurality of syntactic structures.

### Rough Syntactic Analysis

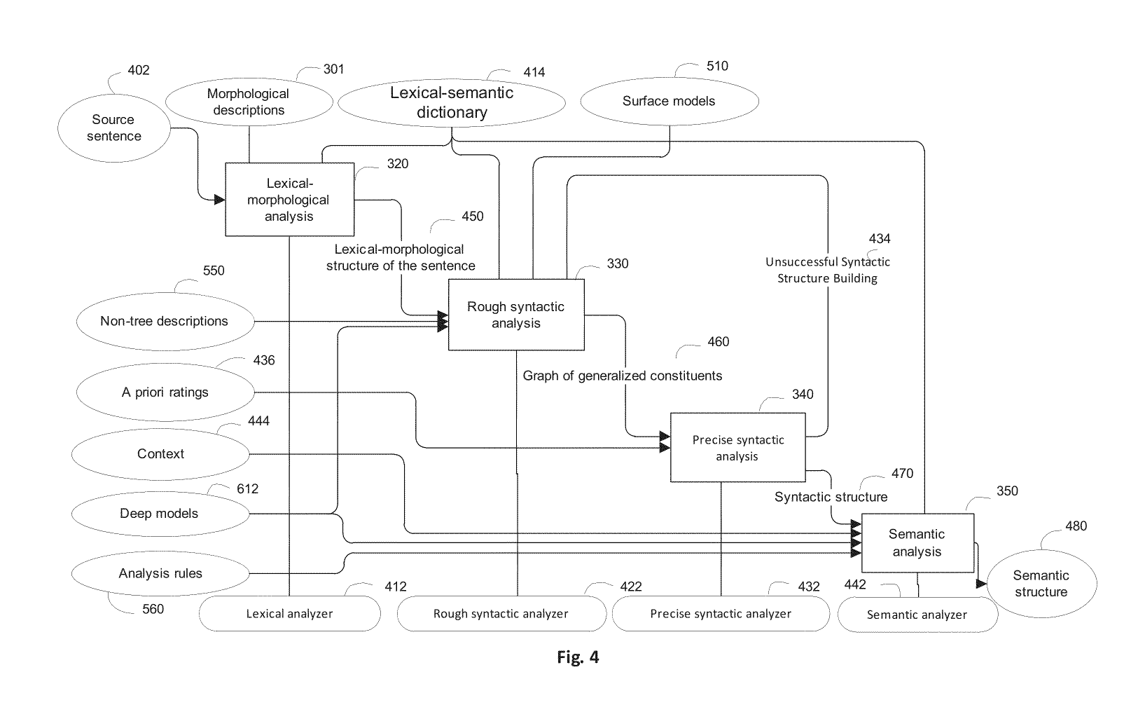

FIG. 4 illustrates the scheme of step 306, which includes the rough syntactic analyzer 422 or its equivalents, used to determine all of the potential syntactic links in a sentence, expressed in creating a graph 460 of generalized constituents based on the lexical-morphological structure 450 using surface models 510, deep models and the lexical-semantic dictionary 414. The graph 460 of generalized constituents is an acyclic graph where all nodes are generalized (i.e., containing all variants) lexical meanings of words in the sentence, while arcs are surface (syntactic) slots representing different kinds of relations between the related lexical meanings. All possible surface syntactic models for each element of the lexico-morphological structure of the sentence are used as a potential core of the constituents. Next, all of the possible constituents are constructed and generalized in the graph of generalized constituents. Accordingly, all of the possible syntactic models and structures for the source sentence 402 are considered, resulting in the graph of generalized constituents 460 based on the plurality of generalized constituents. The graph of generalized constituents 460 at the surface model level reflects all the potential links between the words of the source sentence 402. Since the number of parsing variants may be generally high, the graph of generalized constituents 460 is excessive and contains many variants for the selection of both the graph node lexical meaning and the graph arc surface slot.

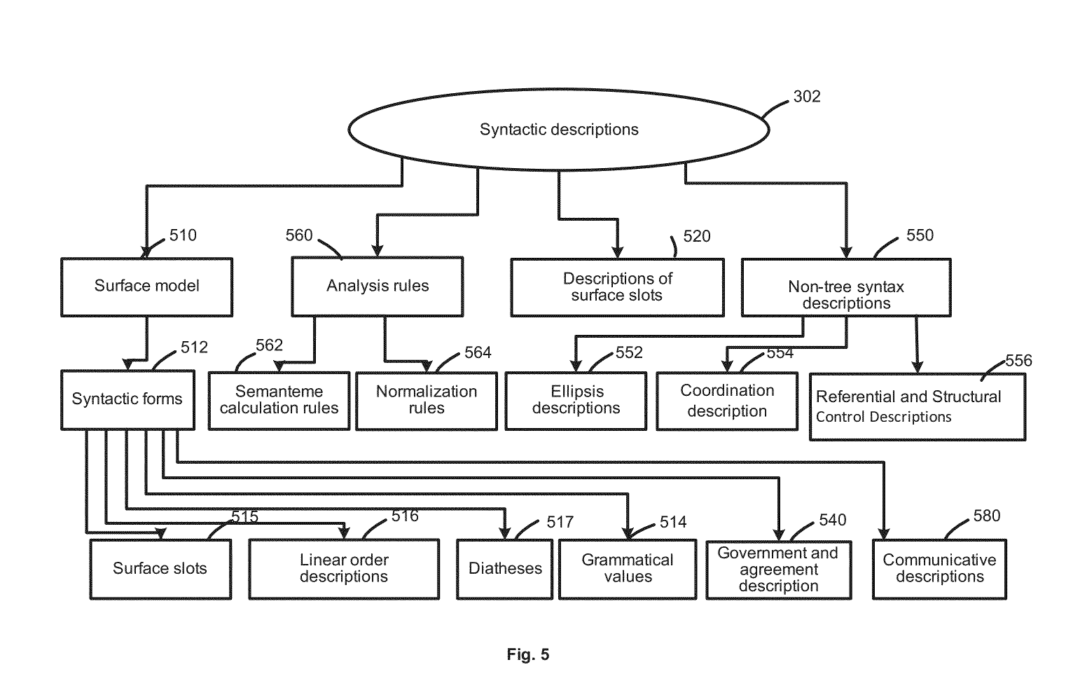

For each “lexical meaning-grammatical value” pair, its surface model is initialized, and other constituents of the syntforms (syntactic forms) 512 surface slots 515 of its surface model 510 are attached to the adjacent constituents on the left and on the right. The syntactic descriptions are provided in FIG. 5. If an appropriate syntactic form is found in the surface model 510 of the respective lexical meaning, the selected lexical meaning may serve as a core of the new constituent.

The graph of generalized constituents 460 is first constructed as a tree, from leaves to roots (from the bottom upwards). Supplementary constituents are constructed from the bottom upwards by attaching the child constituents to parent constituents through filling in the surface slots 515 of the parent constituents in order to cover all of the initial lexemes (lexical units) of the source sentence 402.

The root of the tree is the main part, representing a special constituent corresponding to different types of maximum units of text analysis (complete sentences, numeration, headers, etc.). The core of a main part is usually a predicate. During this process, the tree usually becomes a graph since the low-level constituents (leaves) can be included in various top-level constituents (root).

Some constituents, which are constructed for the same constituents of a lexical-morphological structure, may further be generalized into the generalized constituents. The constituents are generalized based on lexical and grammatical values 514, for example, based on parts of speech or their links, among others. The constituents are generalized by borders (links) since there are many different syntactic links in a sentence and one word can be included in several constituents. The rough syntactic analysis 330 results in the construction of a graph of generalized constituents 460, which represents the whole sentence.

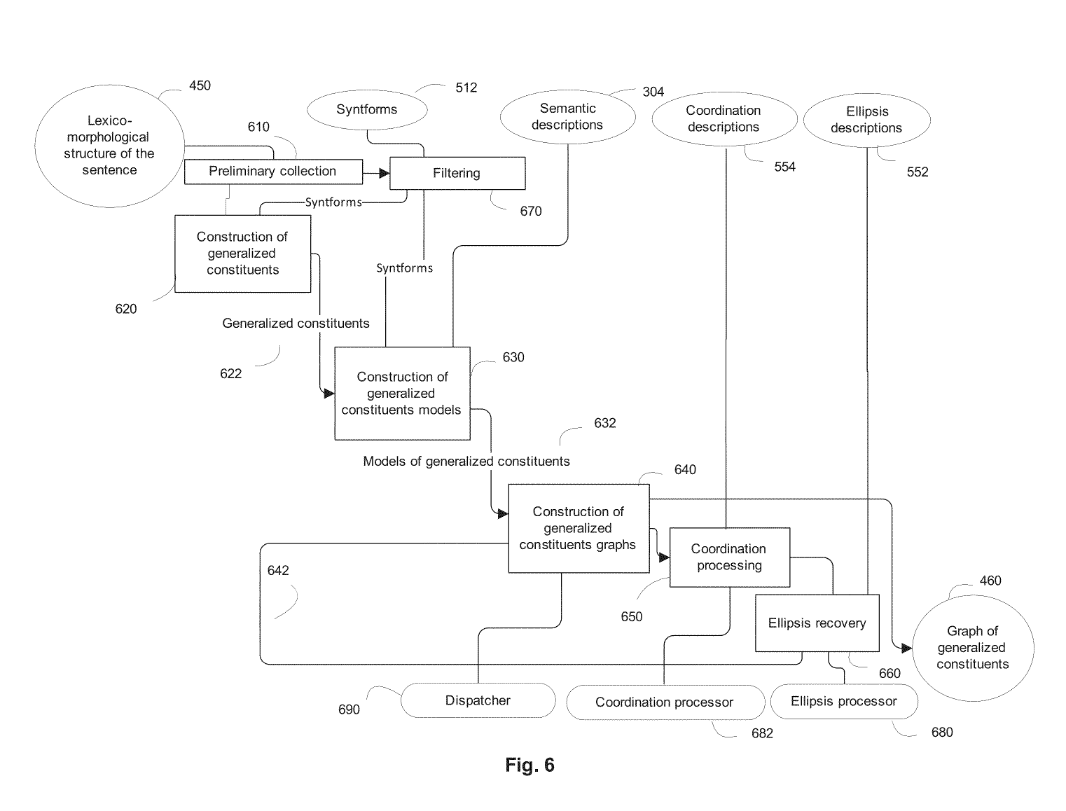

FIG. 6 provides a more detailed illustration of the rough syntactic analysis process 330 according to one or more embodiments of the invention. Rough syntactic analysis 330 usually includes, inter alia, the preliminary collection 610 of constituents, construction of generalized constituents 620, filtering 170, construction 640 of generalized constituent models, processing coordination 650 and ellipses recovery 660.

Preliminary collection 610 of constituents at the rough syntactic analysis step 330 is performed based on the lexical-morphological structure 450 of the sentence being analyzed, including certain groups of words, words in brackets, reverted commas, etc. Only one word in a group (the constituent's core) may attach or be attached to a constituent outside of the group. Preliminary collection 610 is performed at the beginning of rough syntactic analysis 330, before the construction of generalized constituents 620 and of generalized constituent models 630 in order to cover all links in the whole sentence. During rough syntactic analysis 330, the number of various constituents to be constructed and the syntactic links therebetween is very large, so some surface models 510 of constituents are selected in order to sort out, before and after the construction, the constituents during filtering 670, significantly reducing the number of different constituents to be considered. Therefore, the most appropriate surface models and syntforms are selected at the initial rough syntactic analysis step 330 based on a priori ratings. Such a priori ratings include estimates of lexical meanings, fillers and semantic descriptions. Filtering 670 at the rough syntactic analysis step 330 involves filtering multiple syntactic forms (syntforms) 512 and is carried out before and during the construction of generalized constituents 620. Syntforms 512 and surface slots 515 are filtered before, while the constituents are filtered only after their construction. The filtering 670 process allows for a significant reduction of the considered analysis variants. There are, however, unlikely variants of meanings, surface models, and syntforms which, if eliminated from further consideration, may lead to the loss of an unlikely, but possible meaning.

When all possible constituents are built, they are generalized into the generalized constituents 620. All possible homonyms and all possible meanings of elements of the source sentence that may be represented by the same part of speech are collected and generalized, and all possible constituents constructed in such a manner are grouped into generalized constituents 622.

A generalized constituent 622 describes all the constituents with all the possible links in the source sentence having dictionary forms as the general constituents, as well as various lexical meanings for this word form. Next, the generalized constituent models 630 are constructed, as well as multiple models 632 of generalized constituents with generalized models of all the generalized lexemes (lexical units). Models of generalized constituents of lexemes (lexical units) include the generalized deep model and the generalized surface model. The generalized deep model of lexemes (lexical units) includes a list of all deep slots with the same lexical meaning for a lexical unit, as well as descriptions of all the requirements to the fillers of deep slot. The generalized surface model contains information on syntforms 512, which may include a lexical unit, on surface slots 515, diatheses 517 (correspondences between surface slots 515 and deep slots), and a linear order description 516.

Diathesis 517 is constructed at the rough syntactic analysis step 330 as the correspondence between generalized surface models and generalized deep models. A list of all possible semantic classes for all diatheses 517 of a lexical unit is calculated for each surface slot 515.

As shown in FIG. 6, information from the syntforms 512 of the syntactic description 302, as well as semantic descriptions 304, is used to construct the models 632 of generalized constituents. For instance, dependent constituents are attached to each lexical meaning; and the rough syntactic analysis 330 is required to establish whether a potential constituent or a dependent constituent can be a filler for the respective deep slots of the semantic description 304 of the main constituent. Such comparative analysis allows incorrect syntactic links to be cut off at the initial stage.

Next, the graph of generalized constituents is constructed 640. The graph of generalized constituents 460 describes all possible syntactic structures of the whole sentence by interlinking and collecting generalized constituents 622.

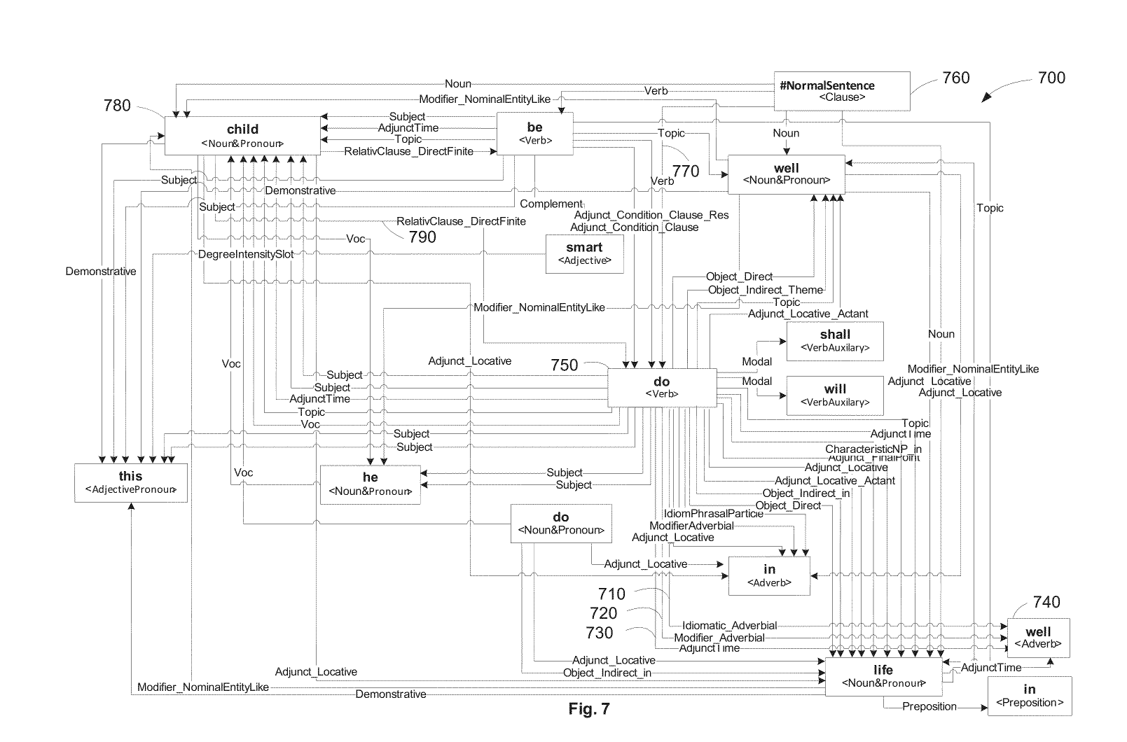

FIG. 7 demonstrates an exemplary graph of generalized constituents 700 for the sentence “This child is smart, he'll do well in life”. The constituents are represented as rectangles, where each constituent has a lexical unit as its core. The morphological paradigm (which is usually a part of speech) of the constituent's core is represented by grammemes of the speech parts and is showed in brackets below the lexemes (lexical units). The morphological paradigm as part of the inflections description 410 of the morphological description contains the complete information on the inflection of one or more parts of speech. For example, since “do” may have two parts of speech: <Verb>, <Noun> (represented by the generalized morphological paradigm <Noun&Pronoun>), two constituents for “do” are represented in the graph 700. Besides, the graph contains two constituents for “well”. Since the source sentence uses a contraction for “ll”, the graph contains two possible variants for contracting “will” and “shall”. The aim of precise syntactic analysis is to select only those potential constituents that will form the syntactic structure of the source sentence.

The links in the graph 700 represent the filled surface slots of the constituent's core. The name of the slot is indicated on the graph arrow. The constituent is formed by the lexical unit's core, which may have outgoing named arrows denoting surface slots 515 filled by child constituents in conjunction with child constituents per se. An incoming arrow denotes the attachment of this constituent to the surface slot of another constituent. The graph 700 is very complex and has many arrows (branches) because it reflects all possible links between the constituents of the sentence. Of course, these include links that will be rejected. The meaning of previously mentioned rough analysis methods is saved for each arrow indicating a filled deep slot. Only the surface slots and links with a high rating will be selected primarily at the next syntactic analysis step.

Often, several arrows may link the same pairs of constituents. This means that there are several suitable surface models for this pair of constituents, and several surface slots of parent constituents may be filled by these child constituents independently. Thus, three surface slots: Idiomatic_Adverbial 710, Modifier_Adverbial 720, and AdjunctTime 730 of the parent constituent “do<Verb>” 750 may be independently filled by the child constituent “well<Verb>” 740 according to the surface model of the constituent “do<Verb>.” Therefore, loosely speaking, “do<Verb>” 750+“well<Verb>” form a new constituent with the “do<Verb>” core, which is linked to another parent constituent, for instance, #NormalSentence<Clause> 660 in the “Verb” 770 surface slot, and to “child<Noun&Pronoun>” 790 in the RelativClause_DirectFinite 790 surface slot. The #NormalSentence<Clause> marked element, being a “root”, conforms to the whole sentence.

As shown in FIG. 6, coordination processing 650 is also performed for the graph of generalized constituents 460. Coordination is a linguistic phenomenon which takes place in sentences with numeration and/or copulative conjunctions such as “and”, “or”, “but”, etc. A simple example of a sentence with coordination is “John, Mary, and Bill come home”. In this case, only one of the child constituents is attached to the surface slot of the parent constituent during the construction 640 of the graph of generalized constituents. If a constituent that may be a parent constituent has a surface slot filled in for a coordinated constituent, all the coordinated constituents will be taken and an attempt will be made to attach all these child constituents to the parent constituent, even if there is no contact or attachments between the coordinated constituents. At the coordination processing step 650, the linear order and possibility of multiple filling of a surface slot are determined. If the attachment is possible, a preliminary form related to the general child constituent is created and attached. As shown in FIG. 6, the coordination processor 682 or other algorithms can be adapted for processing coordination 650 using coordination descriptions 554 during the construction 640 of the graph of generalized constituents.

The construction 640 of the graph of generalized constituents may prove impossible without ellipsis recovery 660, where an ellipsis is a linguistic phenomenon represented by the absence of a main constituent. The ellipsis recovery process 660 is also required to recover skipped constituents. An example of an elliptic sentence in English may be as follows: “The President signed the agreement and the secretary [signed] the protocol”. Coordination processing 650 and ellipsis recovery 660 are conducted at the step of each dispatcher program cycle 690 after the construction 640 of the graph of generalized constituents, and then the construction 640 may be continued as shown by arrow 642. If required, in case of ellipsis recovery 660 and errors at the rough syntactic analysis step 330 due to, for example, the constituents that are left without any other constituent, only these constituents will be processed.

### Precise Syntactic Analysis

Precise syntactic analysis 340 is performed to extract a syntactic tree from the graph of generalized constituents. This tree, per totality of estimates, is a tree of the best syntactic structure 470 for the source sentence. Multiple syntactic trees may be built, with the most likely syntactic tree taken as the best syntactic structure 470. As shown in FIG. 4, the precise syntactic analyzer 432, or its equivalents, is designed for precise syntactic analysis 340 and creation of the best syntactic structure 470 by calculating ratings using a priori ratings 436 from the graph of generalized constituents 460. A priori ratings 436 include ratings of lexical meanings, such as frequency (or likelihood), ratings of each syntactic construction (such as an idiom, a phrase, etc.) for each element of the sentence, as well as the degree of conformance between a selected syntactic construction and the semantic description of deep slots. Beside a priori estimates, statistical estimates obtained following the training of an analyzer on large text corpora can be used. Integral estimates are calculated and saved.

Next, hypotheses about the general syntactic structure of the sentence are generated. Each hypothesis is presented as a tree which, in turn, is a subgraph of the graph of generalized constituents 460 covering the whole sentence, and estimates for each syntactic tree are calculated. During the precise syntactic analysis 340, hypotheses about the syntactic structure of the sentence are verified by calculating various types of ratings. These ratings are calculated as a degree of correspondence between the constituent filler of deep slot 515 and their grammatical and semantic descriptions, such as grammatical restrictions (for example, grammatical values 514) in syntforms and semantic restrictions for fillers of deep slot of a deep model. Other types of ratings are, inter alia, degrees of freedom of lexical meanings to pragmatic descriptions, which may be absolute and/or conditional statistic ratingsof syntactic structures denoted as surface models 510, and the degree of combinability of their lexical meanings.

Calculated for each type of hypothesis can be obtained based on rough a priori ratings obtained from the rough syntactic analysis 330. For example, a rough ratings is calculated for each generalized constituent in the graph of generalized constituents 460, which allows ratings to be calculated. Different syntactic trees may be constructed with different ratings. Ratings are calculated and further used to create hypotheses about the complete syntactic structure of the sentence. For this purpose, a hypothesis with the highest rating is selected. The rating is calculated while carrying out precise syntactic analysis until a satisfactory result is obtained and the best syntactic tree with the highest rating is constructed.

Thereafter, hypotheses reflecting the most likely syntactic structure of the whole sentence can also be generated and obtained. The syntactic structure 470 is used to generate variants with higher ratings through variants of a syntactic structure with lower ratings 470, and hypotheses about syntactic structures over the course of precise syntactic analysis until a satisfactory result is obtained and the best syntactic tree with the highest ratings is constructed.

The best syntactic tree is selected as a hypothesis about the syntactic structure with the highest ratings, reflected in the graph of generalized constituents 460. This syntactic tree is considered the best (most likely) hypothesis about the syntactic structure of the source sentence 402. Next, non-tree links within the sentence are constructed. Correspondingly, the syntactic tree transforms into a graph as the best syntactic structure 470, being the best hypothesis about the syntactic structure of the source sentence. If no non-tree links can be recovered in the best syntactic structure, the structure with the next best rating is selected for further analysis.

If the precise syntactic analysis fails, or if the most likely hypothesis cannot be determined after the precise syntactic analysis, the system returns 434 from the construction of the failed syntactic structure at the precise syntactic analysis step 340 to the rough syntactic analysis step 330, where all syntforms (not only the best ones) are reviewed during the syntactic analysis. If no best syntactic tree is found or the system failed to recover non-tree links in all the selected “best structures”, an additional rough syntactic analysis 330 is performed, taking into account the “bad” syntforms which were not analyzed before according to the described inventive method.

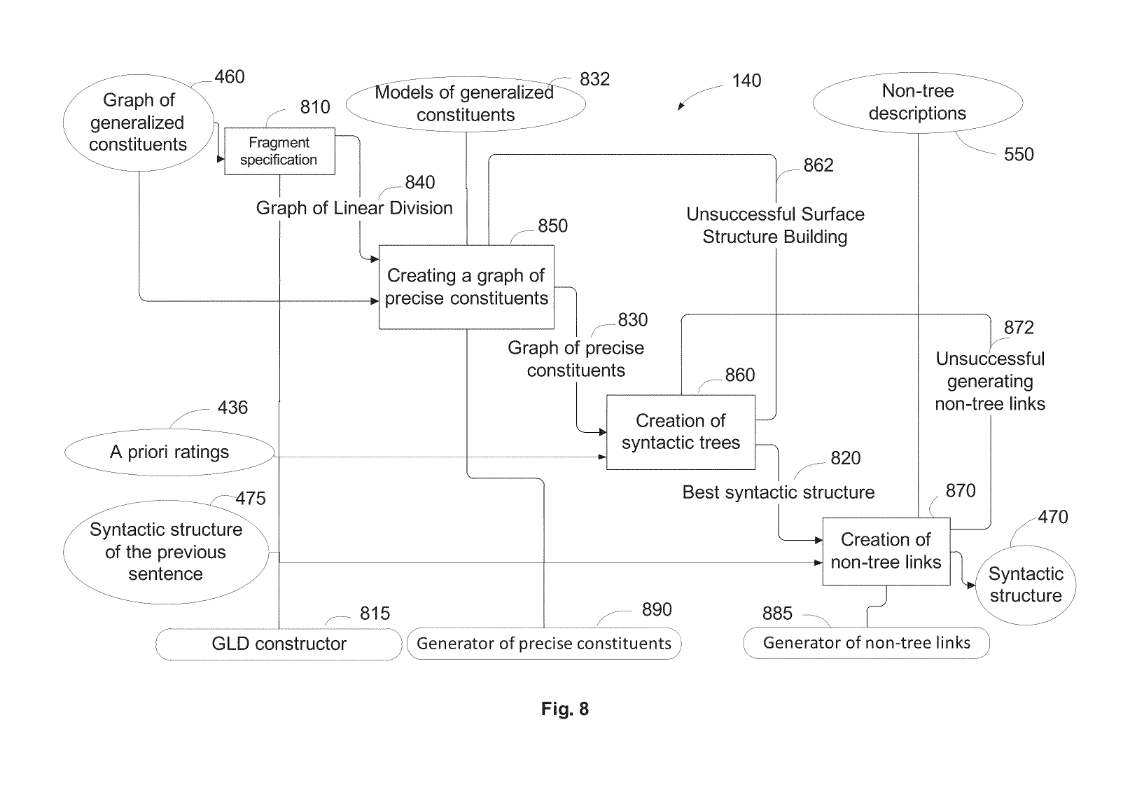

FIG. 8 provides a more detailed illustration of the precise syntactic analysis 340, which is carried out to select a set of best syntactic structures 470 according to one or more embodiments of the invention. The precise syntactic analysis 340 is conducted from top to bottom, from the higher levels to the lower ones, from the potential node of the graph of generalized constituents 460 down to its lower level of child constituents.

The precise syntactic analysis 340 may include various steps, including, inter alia, an initial step 850 of creating the graph of precise constituents, a step 860 of creating syntactic trees and differential selection of the best syntactic structure, and a stage 870 of creating non-tree links and obtaining the best syntactic structure. The graph of generalized constituents 460 is analyzed at the step of preliminary analysis, which prepares the data for the precise syntactic analysis 340.

In the course of the precise syntactic analysis 340, new precise constituents are constructed. The generalized constituents 622 are used to build the graph of precise constituents 830 for creating one or more trees of precise constituents. For each generalized constituent, all possible links and their child constituents are indexed and marked.

Step 860 of creating syntactic trees is carried out to obtain the best syntactic tree 820. Step 870 of recovering non-tree links may use the rules for establishing non-tree links and the information on the syntactic structure 875 of the previous sentences in order to analyze one or more syntactic trees 820 and to select the best syntactic structure 870 among various syntactic structures. Each generalized child constituent may be included in one or more parent constituents in one or more fragments. Precise constituents are the nodes of the graph 830, and one or more trees of precise constituents are created based on the graph of precise constituents 830.

The graph of precise constituents 830 is an intermediate state between the graph of generalized constituents 360 and syntactic trees. Unlike a syntactic tree, the graph of precise constituents 830 may have several alternative fillers for one surface slot. Precise constituents are structured as a graph in such a manner that a specific constituent may be included in several alternative parent constituents in order to optimize further analysis to select a syntactic tree. Therefore, the structure of the intermediate graph is compact enough to calculate the structural rating.

At the recursive step 850 of creating the graph of precise constituents, precise constituents are constructed on the Graph of Linear Division 840 using the left and right links of the constituents' core. For each of them, a path in the linear division graph is constructed and many syntforms are determined, with a linear order being created and checked for each syntform. Thus, a precise constituent is created for each syntform, and the construction of precise child constituents is initiated recursively.

Step 850 results in the construction of a graph of precise constituents that covers the whole sentence. If step 850 of creating the graph of precise constituents 830 failed, which was meant to cover the whole sentence, a procedure aimed at covering the sentence with syntactically separate fragments is initiated.

As shown in FIG. 8, if the graph of precise constituents 830 covering the whole sentence has been built, one or more syntactic trees may be constructed at the creation step 860 in the course of the precise syntactic analysis 340. Step 860 of creating syntactic trees allows one or more trees with a specific syntactic structure to be created. Since the surface structure is fixed in the set constituent, corrections can be made to the structural rating scores, including applied penalty syntforms, which may be complex and not match the style or rating of the contact linear order, etc.

The graph of precise constituents 830 offers several alternatives corresponding to different fragmentations of a sentence and/or to different sets of surface slots. Thus, a graph of precise constituents represents multiple possible syntactic trees, since each slot may have several alternative fillers. The fillers with the best ratings can form precise constituents (a tree) with the best rating. That is why precise constituents are an unambiguous syntactic tree with the best rating. These alternatives are searched for at step 860 and one or more trees with a fixed syntactic structure are constructed. No non-tree links are set in the constructed tree at this step yet. This step results in multiple best syntactic trees 820 having the best ratings.

The syntactic trees are constructed based on the graph of precise constituents. Different syntactic trees are constructed in descending order of their structural ratings. Lexical ratings cannot be fully employed since their deep semantic structure is not yet determined at this step. Unlike the initial precise constituents, each resulting syntactic tree has a fixed syntactic structure, and each precise constituent therein has its own filler for each surface slot.

At step 860, the best syntactic tree 820 may generally be constructed recursively and traversally based on the graph of precise constituents 830. The best syntactic subtrees are constructed for the best child precise constituents, with the syntactic structure based on a set precise constituent and the child subtrees attached to the formed syntactic structure. The best syntactic tree 820 may be constructed, for instance, by selecting the surface slot of the best quality among other surface slots of this constituent, and by creating a copy of the child constituent having a subtree of the best quality. This procedure is applied recursively to a child precise constituent.

Based on each precise constituent, a number of best syntactic trees with a specific rating can be generated. This rating may be pre-calculated and specified in the precise constituents. Once the best trees have been generated, a new constituent is created based on the previous precise constituent. This new constituent, in turn, generates syntactic trees with the second-best ratings. Accordingly, based on a precise constituent, the best syntactic tree may be constructed using this precise constituent.

For example, two types of ratings may be generated for each precise constituent at step 860: the quality of the best syntactic tree that can be constructed using this precise constituent, and the quality of the second-best tree. Besides, a syntactic tree rating is calculated using this precise constituent.

The syntactic tree rating is calculated using the following values: the structural rating of the constituent; the top rating for a set of lexical meanings; the top deep statistics for child slots; the rating of child constituents. When the precise constituent has been analyzed in order to calculate the rating of a syntactic tree that may be created on the basis of the precise constituent, child constituents with the best ratings are analyzed in the surface slot.

At step 860, the calculation of the second-best syntactic tree rating differs only in that for one of the child slots, its second-best constituent is selected. Any syntactic tree with minimum losses of rating in relation to the best syntactic tree must be selected at step 860.

At the end of step 860, a syntactic tree with a fully determined syntactic structure is constructed, i.e., the syntactic form, child constituents, and surface slots they fill are determined Once this tree has been created based on the best hypothesis about the syntactic structure of the source sentence, this tree is regarded as being the best syntactic tree 820. A return 862 from the creation 860 of syntactic trees to the construction 850 of a graph of generalized constituents is provided when there are no syntactic trees with a satisfactory rating, or if the precise syntactic analysis fails.

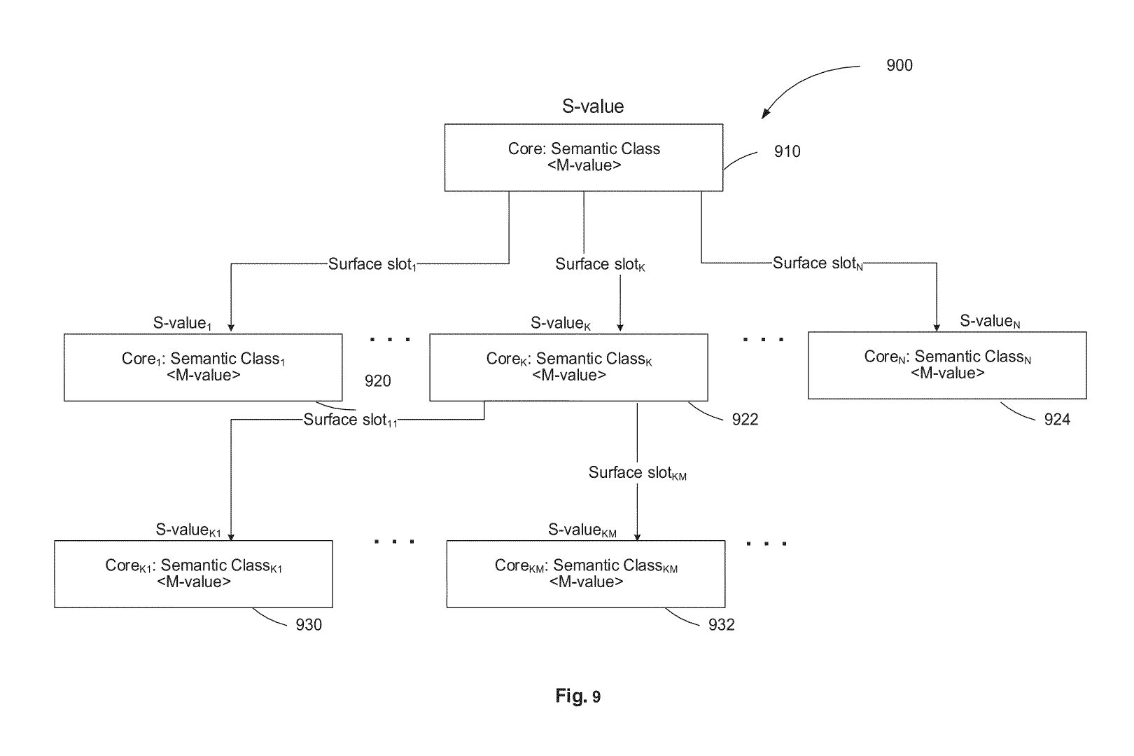

FIG. 9 schematically illustrates an exemplary syntactic tree according to one or more embodiments of the invention. In FIG. 9, the constituents are presented as rectangles, and arrows indicate filled surface slots. A constituent has a word with its morphological value (M-value) as its core, as well as a semantic ancestor (Semantic Class), and may have lower-level child constituents attached. This attachment is shown with arrows, each named Slot. Each constituent also has a syntactic value (S-value) presented as grammemes of syntactic categories. These grammemes are a quality of syntactic forms, selected for the constituent in the course of the precise syntactic analysis 340.

Returning to FIG. 3, at step 307, a language-independent semantic structure reflecting the sense of the source sentence is constructed. This step may also include a reconstruction of referential links between sentences. An example of a referential connection is anaphora—the use of expressions that can be interpreted only via another expression, which typically appears earlier in the text.

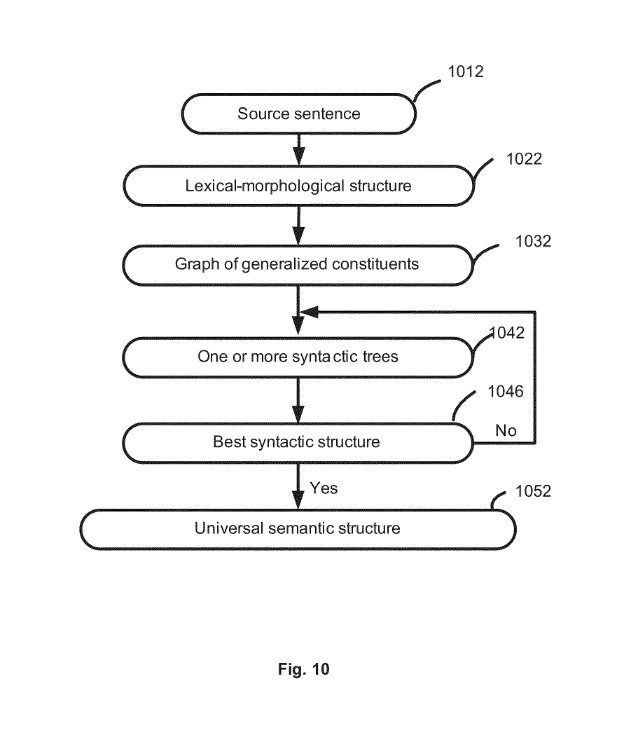

FIG. 10 illustrates a detailed scheme of the method of analyzing a sentence according to one or more embodiments of the invention. Referring to FIG. 3 and FIG. 10, the lexical-morphological structure 1022 is determined at the step of analyzing 306 the source sentence 305.

Next, syntactic analysis is performed, implemented as a two-step algorithm (rough syntactic analysis and precise syntactic analysis) using linguistic models and information of various levels to calculate probabilities and generate a plurality of syntactic structures.

As noted above, rough syntactic analysis is applied to the source sentence and includes, in particular, generation of all potential lexical meanings of the words forming a sentence or a phrase, all potential relationships therebetween and all potential constituents. All possible surface syntactic models are applied for each element of a lexical-morphological structure. Next, all possible constituents are created and generalized so that all possible variants of syntactic parsing for the sentence are presented. This forms a graph of generalized constituents 1032 for subsequent precise syntactic analysis. The graph of generalized constituents 1032 contains all potential links in the sentence. Rough syntactic analysis is followed by precise syntactic analysis of the graph of generalized constituents, in which a plurality of syntactic trees 1042 representing the structure of the source sentence is extracted from the graph. The construction of a syntactic tree 1042 includes a lexical selection for the graph nodes and a selection of relationships between these graph nodes. The set of a priori and statistical ratings can be used to choose lexical variants and relationships from the graph. A priori and statistical ratings can also be used both for estimating both parts of the graph and the entire tree. At this point, non-tree links are verified and built.

The language-independent semantic structure of a sentence is presented as an acyclic graph (a tree supplemented with non-tree links) where each word of a specific language is replaced with universal (language-independent) semantic entities, herein referred to as semantic classes. The core of the existing system, which includes various NLP applications, is the Semantic Hierarchy, ordered into a hierarchy of semantic classes where a child semantic class and its descendants inherit most of the properties of the parent and all preceding semantic classes (“ancestors”). For example, the SUBSTANCE semantic class is a child class of a rather wide ENTITY class and the parent for GAS, LIQUID, METAL, WOOD_MATERIAL, etc. semantic classes. Each semantic class in the semantic hierarchy has a deep (semantic) model. A deep model is a set of deep slots (types of semantic relations in sentences). Deep slots reflect semantic roles of the child constituents (structural units of the sentence) in various sentences where the core of the parent constituent belongs to this semantic class and the slots are filled by various semantic classes. These deep slots express semantic relations between the constituents, for example, “agent”, “addressee”, “instrument”, “quantity”, etc. The child class inherits and adjusts the deep model of the parent class.

Semantic hierarchy is arranged such that the more general notions are closer to the top of the hierarchy. For example, in case of the document types illustrated, the following semantic classes: PRINTED_MATTER, SCIENTIFIC_AND_LITERARY_WORK, TEXT_AS_PART_OF_CREATIVE_WORK and others are descendants of the TEXT_OBJECTS_AND_DOCUMENTS class, and the PRINTED_MATTER class is, in turn, the parent of the EDITION_AS_TEXT semantic class which contains the PERIODICAL and NONPERIODICAL classes, where PERIODICAL is the parent class for the ISSUE, MAGAZINE, NEWSPAPER, etc. classes. The classification approach may vary. The present invention is primarily based on the use of language-independent notions.

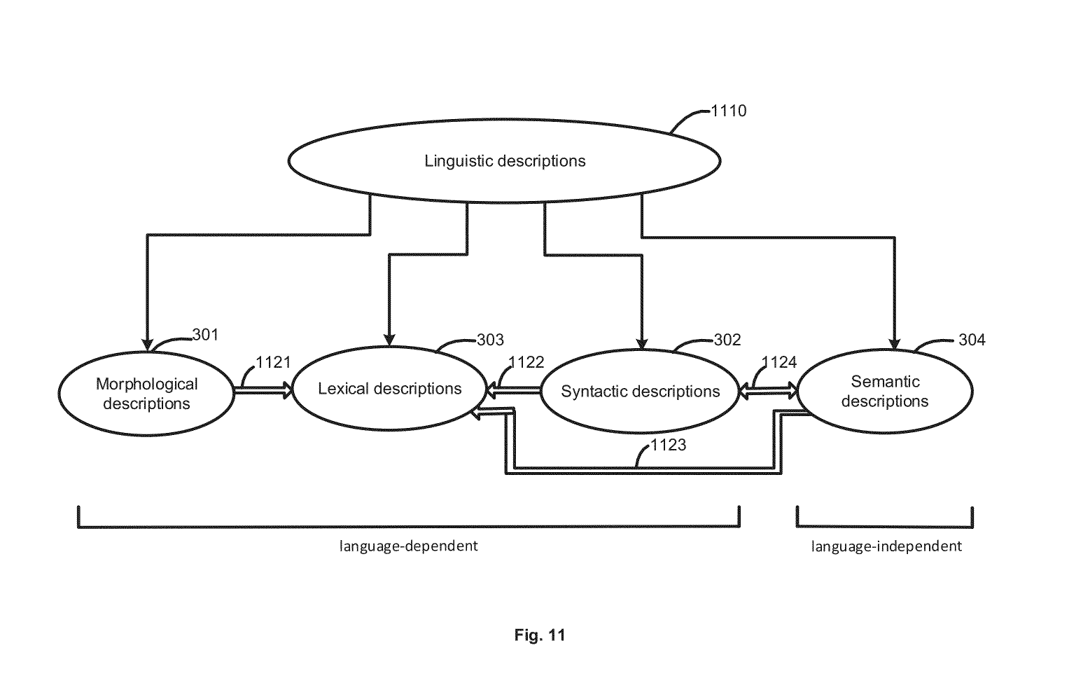

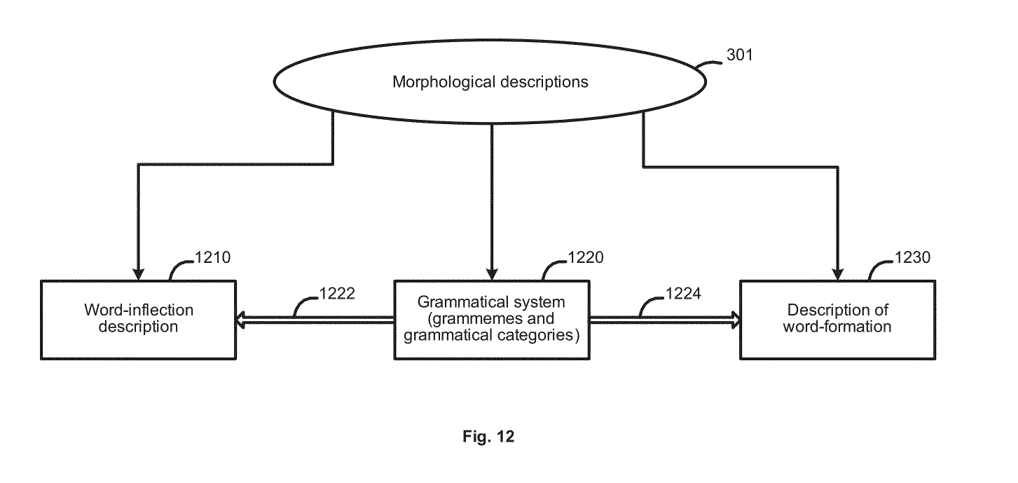

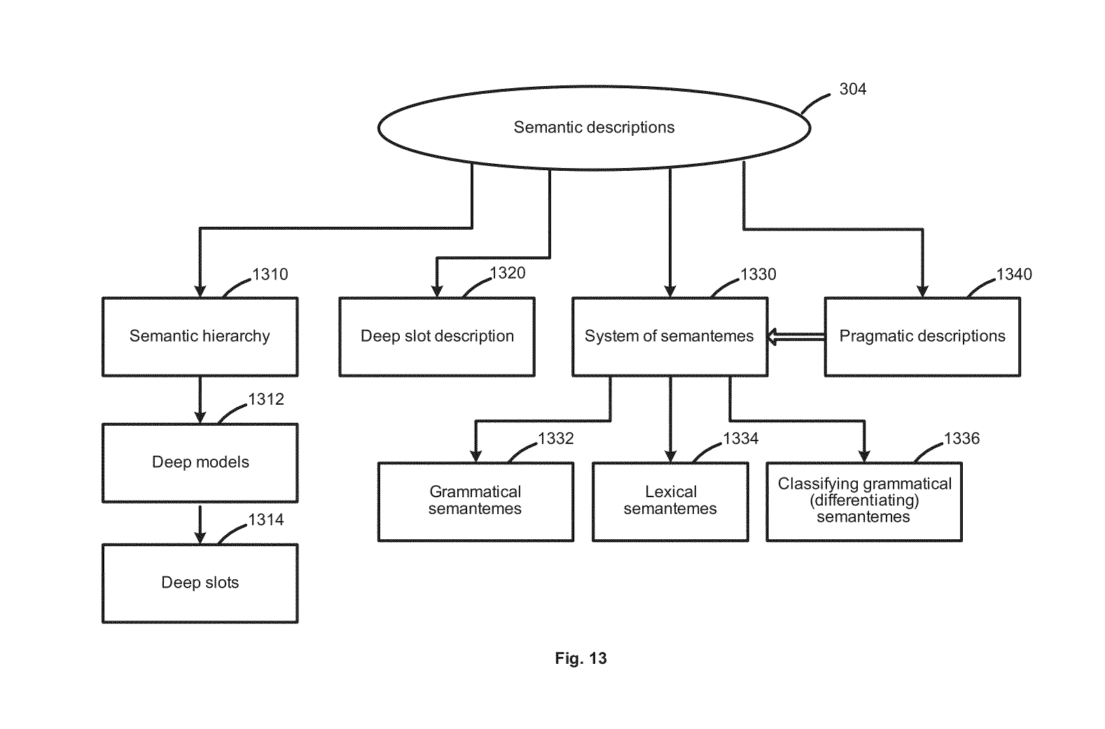

FIG. 11 is a scheme illustrating linguistic descriptions 1110 according to one of the embodiments of this invention. The linguistic descriptions 1110 include morphological descriptions 301, syntactic descriptions 302, lexical descriptions 303, and semantic descriptions 304. Linguistic descriptions 1110 are consolidated in a general concept. FIG. 12 is a scheme illustrating morphological descriptions according to one of the embodiments of this invention. FIG. 5 illustrates syntactic descriptions according to one of the embodiments of this invention. FIG. 13 illustrates semantic descriptions according to one of the embodiments of this invention.

A semantic hierarchy can be created just once and then populated for each specific language. A semantic class in a specific language includes lexical meanings with their models. Semantic descriptions 304 are language-independent. Semantic descriptions 304 may contain descriptions of deep constituents, semantic hierarchy, descriptions of deep slots, a system of semantemes and pragmatic descriptions.

Referring to FIG. 11, in one embodiment of the invention, morphological descriptions 301, lexical descriptions 303, syntactic descriptions 302, and semantic descriptions 304 are related. A lexical meaning may have several surface (syntactic) models determined by semantemes and pragmatic characteristics. Syntactic descriptions 302 and semantic descriptions 304 are related as well. For example, a diathesis of syntactic descriptions 302 can be considered an “interface” between the language-specific surface models and language-independent deep models of the semantic description 304.

FIG. 12 illustrates an example of morphological descriptions 301. As shown, the constituents of morphological descriptions 301 include, but are not limited to, inflection descriptions 1210, a grammatical system (grammemes) 1220, and descriptions of word-formation 1230. In one embodiment of the invention, the grammatical system 1220 includes a set of grammatical categories, such as “Part of speech”, “Case”, “Gender”, “Number”, “Person”, “Reflexivity”, “Tense”, “Aspect” and their meanings, hereafter referred to as grammemes.

FIG. 5 illustrates syntactic descriptions 302. The components of syntactic descriptions 302 may comprise surface models 510, surface slot descriptions 520, referential and structural control descriptions 556, government and agreement descriptions 540, non-tree descriptions 550, and analysis rules 560. Syntactic descriptions 402 are used to construct possible syntactic structures of a sentence for a given source language, taking into account the word order, non-tree syntactic phenomena (e.g., coordination, ellipsis, etc.), referential control (government) and other phenomena.

FIG. 13 illustrates semantic descriptions 304 according to one of the embodiments of this invention. While surface slots 520 reflect syntactic relationships and how they can be realized in a specific language, deep slots 1314 reflect semantic roles of child (dependent) constituents in deep models 1312. Therefore, descriptions of surface slots—and more broadly, surface models—can be specific for each particular language. Descriptions of deep models 1320 contain grammatical and semantic restrictions on these slot fillers. Properties and restrictions of deep slots 1314 and their fillers in deep models 1312 are very similar and often identical for different languages.

The system of semantemes 1330 is a set of semantic categories. Semantemes can reflect lexical and grammatical properties and attributes, differential properties, as well as stylistic, pragmatic and communicative characteristics. For instance, the DegreeOfComparison semantic category can be used to describe degrees of comparison expressed by different forms of adjectives, for example, “easy”, “easier” and “easiest.” Thus, the DegreeOfComparison semantic category can include semantemes, for example, “Positive”, “ComparativeHigherDegree”, “SuperlativeHighestDegree”. Lexical semantemes can describe specific properties of objects, for example, “being flat” or “being liquid” and can be used as restrictions on fillers of deep slots. Classifying differential semantemes are used to express differential properties within one semantic class. Pragmatic descriptions 1340 serve to register the subject matter, style or genre of the text and to ascribe corresponding characteristics to the objects of the semantic hierarchy during text analysis. For example, “Economic Policy”, “Foreign Policy”, “Justice”, “Legislation”, “Trade”, “Finance”, etc.

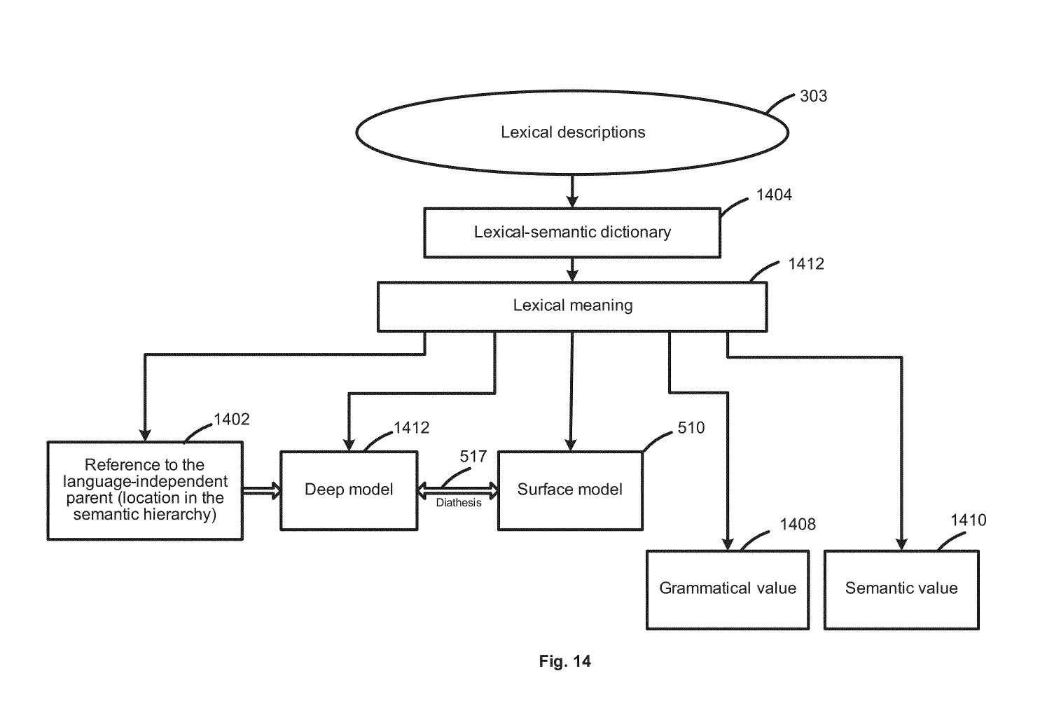

FIG. 14 is a scheme illustrating lexical descriptions 303 according to one or more embodiments of the invention. Lexical descriptions 303 include a lexical-semantic dictionary 1404 which contains a set of lexical meanings 1412 that, together with their semantic classes, form a semantic hierarchy where each lexical meaning can include, but is not limited to, its deep model 1412, surface model 410, grammatical value 1408 and semantic value 1410. A lexical meaning can combine various derivatives (for example, words, expressions, phrases) that express the meaning with the help of various parts of speech, various word forms, words with the same root, etc. The semantic class, in turn, combines lexical meanings of words and expressions with similar meanings in different languages.

Thus, lexical, morphological, syntactic and semantic analyses of a sentence are performed, resulting in the construction of the optimal semantic and syntactic tree for each sentence. The nodes of this semantic and syntactic graph are dictionary units of the source sentence with assigned semantic classes (SC), being elements of the Semantic Hierarchy.

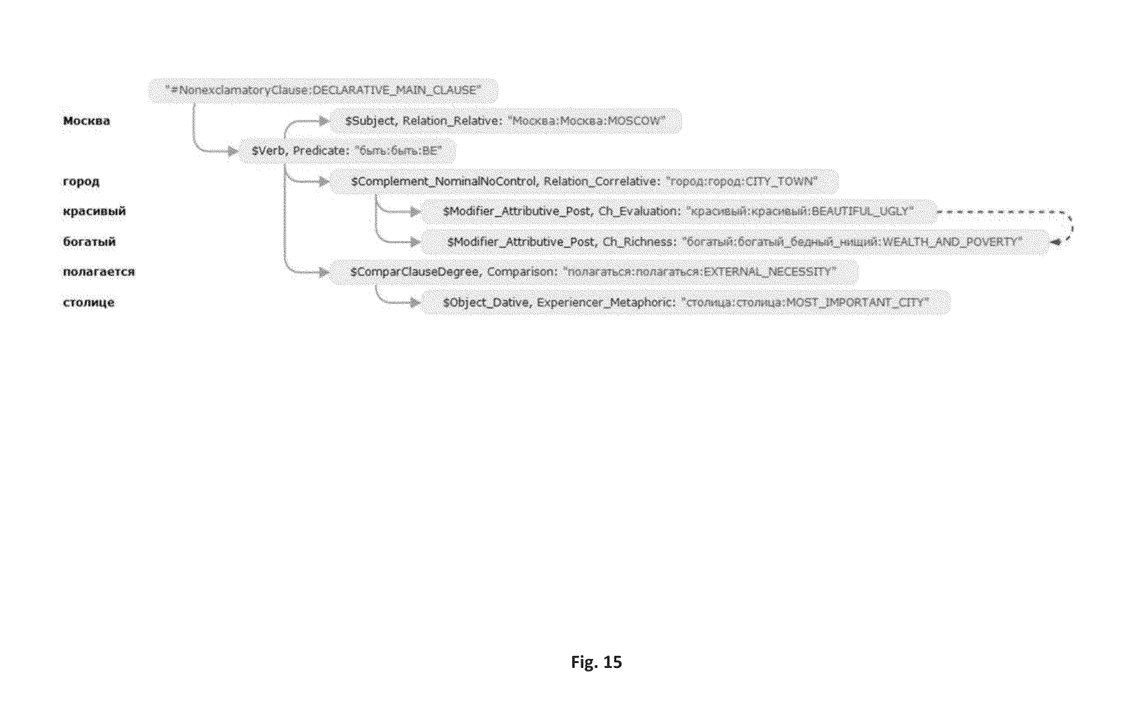

FIG. 15 illustrates a semantic structure scheme obtained by analyzing the sentence “ [symbol] [symbol] [symbol] [symbol] [symbol] [symbol] ” (“Moscow is a rich and beautiful city as all proper capitals”). This structure is independent of the source sentence language and contains all of the information required to determine the meaning of this sentence. This data structure contains syntactic and semantic information, such as semantic classes, semantemes (not shown), semantic relations (deep slots), non-tree links, etc., sufficient to reconstruct the meaning of the source sentence in the same or another language.

### Fact Extraction Module:

The disclosed invention implies the use of a fact extraction module. The purpose of fact extraction is automated, computer-aided extraction of entities and facts through processing texts or text corpora. One of the extracted facts is an extracted sentiment. In the disclosed invention, such text message analysis can result in an extraction of the main topics, events, actions, etc. that are discussed in the messages. The fact extraction module uses previous (at step 330 of FIG. 1) steps of parser operations (namely, lexical, morphological, syntactic, and semantic analyses of the sentence).

At step 340, the fact extraction module receives the input of semantic and syntactic parsing trees obtained as a result of the parser operation. The fact extraction module constructs a directed graph, with the nodes being information objects of different classes, and its arcs describing the links between the objects. The extracted facts can be represented in line with the RDF (Resource Definition Framework) concept.

Information objects are supposed to possess certain properties. Properties of an informational object may be set, for example, using the <s,p,o> vector, where s is a unique object ID, p is a property ID (predicate), and o is a simple type value (string, number, etc.).

Information objects may be interlinked by object properties or links. An object property is set using the <s,p,o> combination, where s is a unique object ID, p is a relation ID (predicate), and o is a unique ID of another object.

The rule-based approach is used during fact extraction. These rules are templates compared to fragments of the semantic and syntactic tree to create elements of the information RDF graph.

The following rule is an example:

```
“BE” | “TO_THINK_CONSIDER”
    [Relation_Relative: !obj ~<<NonPredicativeNegative>> ]
    [Relation_Correlative: !sent <%SentimentTag%>]
    [Experiencer:  ?!subj  <%  AbstractObject  |  Subject  %>
~<<NonPredicativeNegative>> ]
    [?x “NEGATIVE_PARTICLES”]
  { <<Negative>> =>
  specify (sent.o, Sentiment), anchor (sent.o, this, NoDistribution),
  sent.o.negs_count == 6,
  sent.o.sentiment_subject == subj.o, sent.o.sentiment_subject == subj.o.rel_entity,
  UnknownObjectOfSentimentString O (obj),
  sent.o.sentiment_object == O,
  sent.o.sentiment_object == O.substitute;
```

Graphs generated by the fact extraction module are aligned with the formal description of the domain or an ontology, where an ontology is a system of concepts and relations describing a field of knowledge. An ontology includes information about the classes to which information objects may belong, the possible attributes of objects of different classes, as well as possible values of the attributes.

### Construction of Tree-Like Structures for Discussed Topics:

In one embodiment of the present invention, a graph, for instance, in a tree-like form can be created. The graph is generated using information on entities extracted from analyzed messages, i.e., the key topics of discussion.

Extraction of message topics can be performed using the text contained in the Subject field. Besides, message topics can be obtained using the fact extraction module at step 140. In addition, an index of the topic count in text data (messages) can be calculated. The extracted topics can be sorted since the most discussed ones are of the greatest interest. After sorting, the most discussed topics can be selected for graph generation based on a threshold value of the index of the topic count in text messages. The threshold value can be preset or selected. Moreover, the graph can be generated based on the entire array of the extracted topics.

Often, a topic may generate another topic and so on in the course of a discussion of a topic (event, etc.). This invention enables tracking of how the discussed topics are interrelated. This is particularly useful for the most discussed topics, i.e., topics to which employees respond the most.

A node of the graph is an extracted topic (subject of a message). Arcs of the graph reflect the links between the topics. In addition, each element of the graph can be expanded so that the expanded (additional) information will include the message participants, their opinions, the message sending time, etc. Thus, a user can select a topic and see a pop-up window with detailed information on the discussion participants.

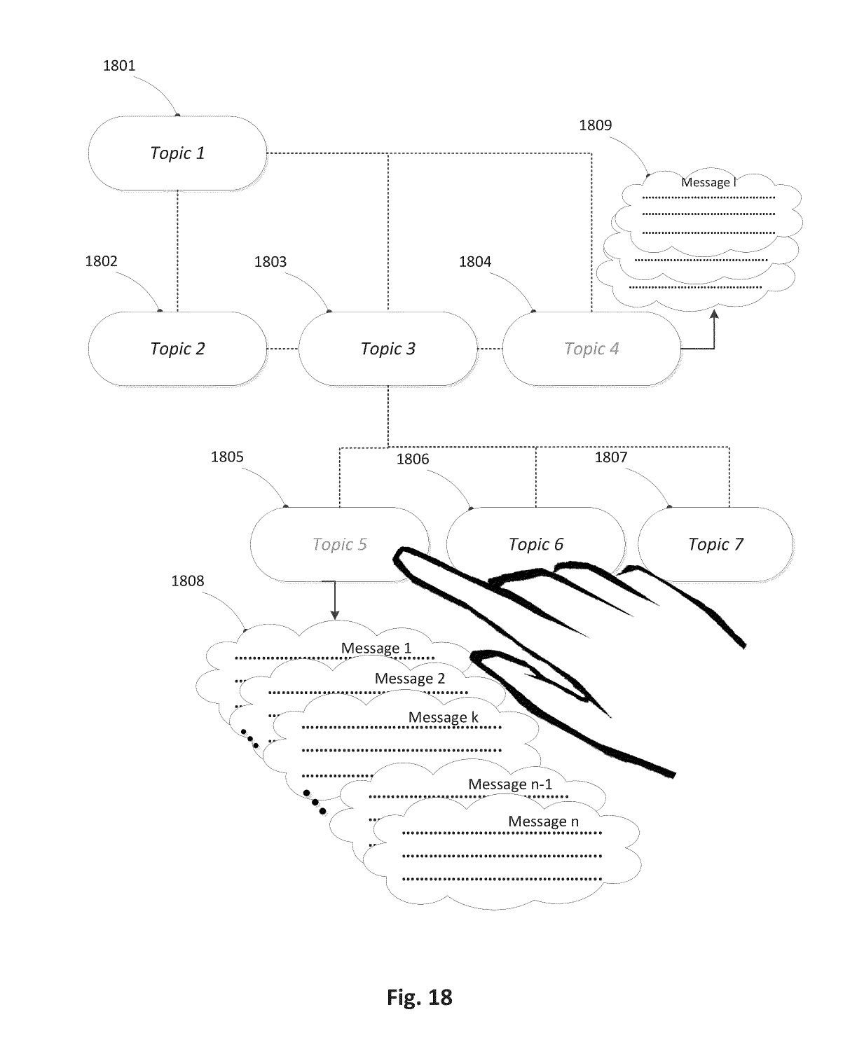

FIG. 18 illustrates an example of such a structure. FIG. 18 shows that an analysis of the text message has identified topic 1 (1801), and topic 1 (1801) creates three new message topics: 2 (1802), 3 (1803), and 4 (1804), which are also interlinked. The user can view the text messages (1808, 1809) for each of the selected topics.

### Leaders Identification:

The method of analyzing text data (such as e-mails and forum posts) based on extracted entities and facts allows informal leaders to be identified.

Extracted entities and facts, or content of the Sender field (or another characteristic (prop) word), are used to generate a graph reflecting social interactions among company employees. This graph can be visually rendered on a user screen. A node of the graph corresponds to a company employee (an e-mail sender/recipient), while an arc reflects the fact of interaction between employees. Thus, if company employees have never communicated via e-mail, there will be no connecting arc between the nodes. If an instance of communication has been registered, the arc will connect the node of the first employee to the node of the second one. This graph can be constructed based on information covering different periods: a day, a week, a month, etc.

A graph constructed this way, reflecting social interactions among employees, allows the most active correspondents to be identified. The nodes of the most active correspondents will be connected to the largest number of arcs. This criterion can be used to search for leaders among employees.

The graph can be constructed both between employees and between business units. It can also be constructed to reflect interactions with external companies (based on communications with employees of external companies).

### Sentiment Identification Model:

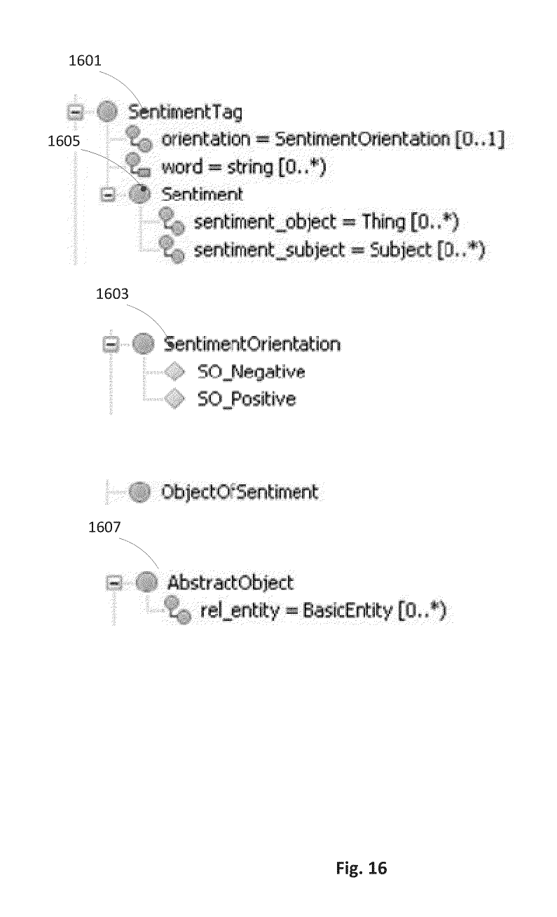

FIG. 16 demonstrates a model that may be used for text data sentiment identification.

According to the model, “SentimentTag” 1601 is a sentiment tag that can be seen as a hypothesis about an emotional (sentiment) coloring. It can be characterized by a sentiment sign. For example, the Word type attribute contains a sequence of words used to make a decision about a sentiment sign.

“SentimentOrientation” 1603 tag refers to a sentiment sign. In one embodiment of the invention, a sentiment sign may have two values: positive or negative.

“Sentiment” 1605 tag refers to a sentiment. It derives relations from “SentimentTag” 1601 and may also refer to the object and the subject of the sentiment. An object in this case may be any entities or facts described in the ontology and identified by the fact extraction module. A subject is any entity indicated in the ontology. For example, instances of the Subject concept, combining persons, organizations, and locations, can be subjects. Subjects and objects of a sentiment are determined on the basis of extracted entities.

Sentiment objects not described in the ontology are identified as instances of this concept. In addition, the auxiliary concept of AbstractObject 1607 may be used to identify sentiment objects.

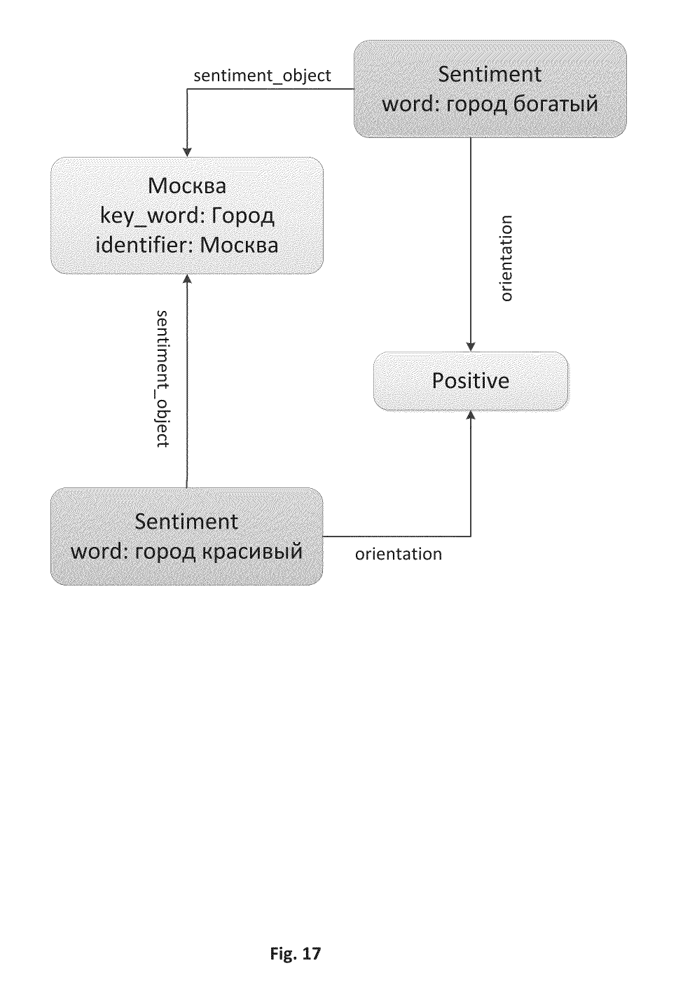

FIG. 17 shows an example of an informational RDF graph, being an example of parsing the sentence, “Moscow is a rich and beautiful city as all proper capitals”.

### Sentiment Lexicon:

It is known that there are emotionally colored words and phrases, such as positive or negative ones. Such sentiment words may serve as a tool of semantic analysis.

The described text sentiment identification analysis uses a sentiment lexicon. A sentiment lexicon can be formed manually, on the basis of the Semantic Hierarchy (SH) described in U.S. Pat. No. 8,078,450. Pragmatic classes and semantemes can be used to form a sentiment lexicon.

For example, pragmatic classes directly reflecting the sentiment (negative or positive) can be used. Pragmatic classes may reflect a domain. Pragmatic classes can be created manually and ascribed at the level of semantic classes and lexical classes.

The system of semantemes is a set of semantic categories. Semantemes can reflect lexical and grammatical properties and attributes, differential properties, as well as stylistic, pragmatic and communicative characteristics. For instance, the DegreeOfComparison semantic category can be used to describe degrees of comparison expressed by different forms of adjectives, for example, “easy”, “easier”, and “easiest.”

Such semantemes as “PolarityPlus”, “PolarityMinus”, “NonPolarityPlus”, and “NonPolarityMinus” can be used to differentiate antonyms that are semantic derivatives of one lexical class. Since pragmatic classes (PC) are ascribed at the level of lexical classes (LC) and semantic classes (SC), semantemes of antonymic polarity, such as PolarityPlus, are used to differentiate antonyms (they are usually of different signs).

When the lexicon is formed, the vocabulary is divided into several pre-set classes. In one embodiment of the invention, the vocabulary is divided into two classes: positive and negative. In this regard, the vocabulary of the lexicon reflects a positive or negative sentiment independent of the environment (in other words, of context), or in a neutral environment, i.e., without other sentimental words. Examples of words included in a sentiment lexicon are “luxurious”, “breakthrough” (meaning an “utmost achievement”), “vigilant”, “convenience”, etc.

### Determining a Sentiment Sign

A sentiment lexicon constitutes the basis of the sentiment extraction process. According to the sentiment lexicon, instances of SentimentTag are identified, or in other words, a hypothesis about emotional (sentiment) coloring is made. Next, the identified instances are processed and modified, resulting in a decision as to whether the identified instances of the SentimentTag concept are sentiments. In other words, SentimentTag instances are reduced to the concept “Sentiment”.

In this case, processing involves finding the sentiment objects and subjects, as well as determining the sentiment sign depending on various factors. The presence of sentiment subjects and objects allows the presence of a sentiment to be confirmed.

### Negations and Other Inversions of a Sentiment Sign:

According to one embodiment of the invention, a sentiment estimate is performed (as was mentioned above) using a two-point scale that includes two categories: positive and negative.

Negation words are assumed to reverse the sentiment sign. Examples of negations include such words as “not”, “never”, “nobody”, etc. Besides negations, there are other sign reversers.

Below are examples of the rules and situations for deciding whether or not a sentiment sign should be reversed:

For example, one of sign reversers is “negations” of an emotionally colored (sentiment) word or group of words (i.e., of any constituent to which a SentimentTag is ascribed). Negations are identified using semantemes, which are determined during semantic analysis. This allows standardized processing of cases of clear negations (such particles as “not”, “less”, etc.) and examples such as: “Nobody gives a good performance here.”

Another reverser is a degree negation (“(not very) good”). The degree itself, however, does not affect the sign.

Sentiment sign reversers are also called shifters. Examples of shifters are such words as “cease”, “reconsider”, etc. Sentiment shifters are expressions used to change the sentiment orientation, for example, to change a negative orientation to a positive one or vice versa. If a shifter contains negation, it does not affect the sentiment sign. The same is true for shifter antonyms (“continue”, etc.): they affect a sentiment sign in the slot before a negation.

According to the present invention, there is a counter registering the number of reversers accompanying a sentiment instance, followed by determination of the main sentiment sign.

### Modality

Modality is taken into account when determining a sentiment sign. Modality is a semantic category of a natural language reflecting the speaker's attitude towards the object he is speaking about, for example, an optative modality, intentional modality, necessity modality and debitive modality, imperative modality, questions (general and specific), etc.

The fact extraction module processes modality and identifies it separately, independent of sentiment. In an ontology, modality is represented by the concepts of “Optative” and “Optativelnformation”. Despite the name, not only the optative modality is processed, but the debitive, imperative and intentional modalities are as well. Therefore, desire, intention, oughtness and imperative are covered. In addition, all interrogative sentences are seen as a desire to obtain some information. An object and an experiencer of optativeness are identified as well.

Thus, if a sentiment is an object of optativeness:
In case of an Optative concept, the sentiment either reverts its sign or should be annulled. This should be so because “wishing for something good” may exist both per se and because of the existence of an opposite situation. The same reason makes it generally impossible to automatically determine the specific action to be performed over SentimentTag.
In case of interrogative sentences, the decision depends on the type of question.

### Compatibility:

Compatibility should also be considered when determining a sign. Compatibility may be taken into account by observing compatibility rules or collocation dictionaries. Collocation is a phrase possessing syntactic and semantic attributes of an integral unit. An example of a rule for considering compatibility is nominal groups (NG) that are combinations of a noun and an adjective. There may be several emotional words or their groups (SentimentTags), where signs may or may not match. The emotional (sentiment) coloring of their combination depends on the coloring of each of them.

In particular, for nominal groups (noun+adjective), if the noun in a phrase has negative coloring, the whole nominal groups (NG) can be marked as negative. Example: [symbol] [symbol] [symbol] [symbol] [symbol] [symbol] (“I have never seen such outstanding NONSENSE!!!”) Or, if the noun is positive, the sign of the nominal groups (NG) may be determined by the sign of a dependent adjective.

### Identification of Objects and Subjects

The connection between the sentiment (SentimentTags) and objects or subjects is determined based on their function in the sentence, and this connection allows a conclusion to be made about the presence of a sentiment in the sentence. The identification is done within contexts, some of which are listed below. Persons, organizations, etc. may act as subjects. All objects are identified as instances of the ObjectOfSentiment concept. However, when there are entities extracted and linked to the same constituent and described in the ontology, these entities become the objects.

Below are examples of contexts:
To be something (identity relation), to be seen as something;
Inchoate (“N has gotten prettier”);
Authorship (“the masterpiece of director N”);
Characteristic (“remarkable N”, “criminal N”);
Neutral characteristics that may assume coloring (in the context of their increase-decrease). Examples are: unemployment, salary, etc.;
Emotionally colored (sentiment) verbs such as “to love”, “to like”, etc. are assigned to a separate group on the level of the lexicon;
And so on.

Also, slight pre-processing of objects is used, enabling assumption that an object's characterization is attributable to the object itself (the AbstractObject concept is used for this). The following are possible examples of such pre-processing: “N's behavior”, “movie plot” (here no person can be identified for “behavior”, yet the object of characterization must somehow be recognized).

Following the results of the module operation with the collection of texts, it was discovered that usually characteristics or parameters of objects are included in the sentiment object. Thus, in a collection of 874 texts (275 book reviews, 329 film reviews, 270 reviews of digital cameras),
the following were the most frequent for books: book, reading, author, person, character, novel, impression, literature, language, plot, volume, woman, idea, story, etc.;
for films: film, actor, part, hero, volume, cinema, moment, plot, character, person, idea, effect, scene, etc.;
for cameras: quality, shot, purchase, camera, photograph, device, video, shooting, photo, image, mode, zoom, model, menu, price, picture, function, lens, etc.
   Therefore, it is possible to obtain information on the features of entities that are most frequently mentioned in text messages and to use the system as a feature extractor.

Extraction of opinion (emotion) holders and time extraction from text messages can be performed using a previously known structure of such messages. An e-mail (or forum post) usually has corresponding fields containing the sender information and the message sending date.

### Determining a Text Aggregate Function

The primary goal is to determine a sentiment locally, within an aspect. However, in many situations it is important to determine the aggregate, objective sentiment of text data, i.e., the aggregate function of the whole text. Under the aspect-based sentiment analysis, certain weights are ascribed to aspects and entities. Then, using a formula, the aggregate function of the whole sentence or text is calculated. For example, the following formula may be used to determine a sentiment in the i^{th} sentence/text:

Sentimentᵢ=w₁e₁+ . . . wₖeₖ

Considering each word in an e-mail, a sentiment of the whole text message is calculated. Different methods may be used to determine the aggregate function.

As a result of sentiment analysis, every e-mail is classified according to its emotional coloring. However, the number of clusters may vary. For example, e-mails may be classified as negative, neutral, or positive. Each e-mail may be marked according to a certain emotional (sentiment) coloring. The mark may reflect an emotional coloring of the e-mail in different ways: as a color mark, symbol, keyword, etc.

### Document Sentiment Classification

In another embodiment of the invention, the method of determining the sentiment of text messages can be based on the statistical classification method in addition to supervised machine learning.

For that, a locally determined sentiment is used as an attribute for training, as well as a set of new attributes obtained from syntactic and semantic parsing of sentences. It is important to select attributes for the classifier in a correct way. Most often, lexical attributes are used, such as individual words, phrases, specific suffixes, prefixes, capital letters, etc.

For example, the following may serve as attributes: the presence of a term in the text and the frequency of its use (TF-IDF); a part of speech; sentiment words and phrases; certain rules; shifters; syntactic dependency, etc. According to the described method of text sentiment determination, attributes may be of a high level: semantic classes, lexical classes, etc.

The results of text message analysis may be presented in any known way. For example, the results may be presented graphically, in a separate window, in a pop-up window, as a widget on the desktop, in a separate e-mail sent once a day, or otherwise. One display variant is a diagram consisting of several columns, where the height of each column is proportional to the number of e-mails of that “color”.

The invention also allows managers to observe the monitoring results aggregated by a department, and senior managers—the results for the whole company as well. That is, a manager may view the aggregated result for all of his subordinates, or individually, grouped by a specified department.

A forecast can be produced for monitoring purposes, i.e., calculation and presentation of the expected result for a specified period of time, etc.

Text message analysis (such as analysis of corporate mail and special corporate forums) may be performed directly on corporate servers. In other words, this means that the agent software implementing the method of this invention may be physically located on a server used for corporate e-mail. Alternatively, the analysis may be performed in a distributed manner. In this case, the agent software may be installed on all computers where a mailing client operates. In particular, the agent may be a plug-in or add-on to the mailing client.

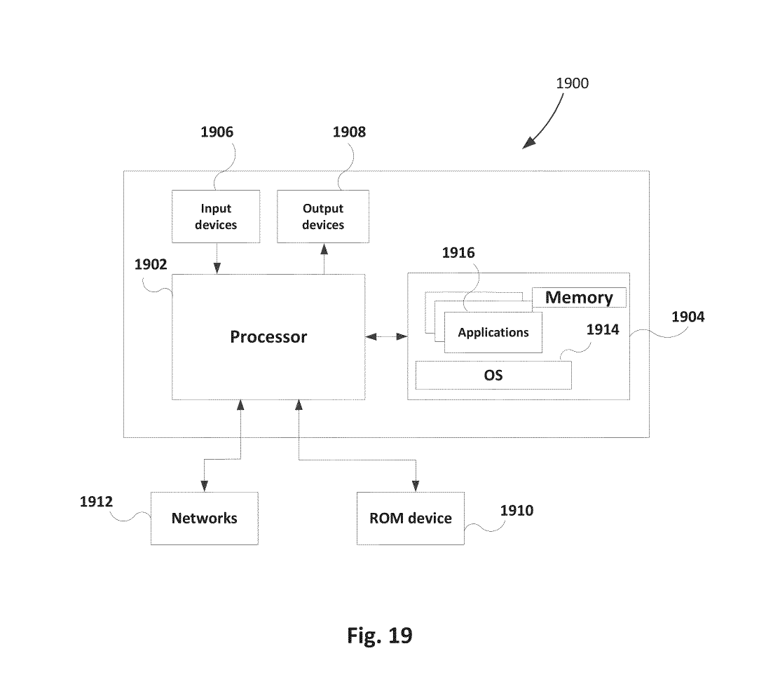

FIG. 19 provides an example of a computing tool 1900. This tool may be used to implement this invention as described above. The computing tool 1900 includes at least one processor 1902 linked to the memory 1904. The processor 1902 may include one or more processors and may contain one, two or more cores. Alternatively, it can be a chip or another computing unit (for example, a laplacian can be obtained optically). The memory 1904 may be a random-access memory (RAM) or it may contain any other types and kinds of memory, including, but not limited to, non-volatile memory devices (such as flash drives) or permanent memory devices, such as hard drives, etc. In addition, the memory 1904 can include storage hardware physically located elsewhere within the computing tool 1900, such as cache memory in the processor 1902, memory used virtually and stored on any internal or external ROM device 1910.

Usually, the computing device 1900 also has a certain number of inputs and outputs for sending and receiving information. For purposes of interaction with the user, the computing device 1900 may contain one or more input devices (such as a keyboard, mouse, scanner, etc.) and a display device 1908 (such as an LCD or signal indicators). The computing device 1900 may also have one or more ROM devices 1910, such as an optical disc drive (CD, DVD, etc.), a hard drive or a tape drive. In addition, the computing device 1900 may interface with one or more networks 1912 providing a connection with other networks and computers. In particular, this may be a local-area network (LAN) or a wireless Wi-Fi network with or without an Internet connection. It is assumed that the computing device 1900 includes suitable analogue and/or digital interfaces between the processor 1902 and each of the components 1904, 1906, 1908, 1910, and 1912.

The computing device 1900 is controlled by an operating system 1914. The device runs various applications, components, programs, objects, modules, etc., aggregately marked by number 1916.

The programs that are run to implement the methods corresponding to this invention may be part of the operating system or a separate application, component, program, dynamic library, module, script or a combination thereof.

This description sets forth the holder's main inventive conception, which shall not be limited to the hardware devices mentioned above. It is worth noting that hardware devices are designed, first of all, to perform narrow tasks. With time and technological progress, these tasks evolve, becoming more complex. New means emerge, capable of satisfying new demands. In this context, hardware devices should be considered in terms of the class of technical tasks they are to perform, rather than in terms of a purely technical implementation on an element base.

What is claimed:

1. A method of text data analysis, including:
obtaining text data;
performing deep syntactic and semantic analysis of text data;
extracting entities and facts from text data based on the results of deep syntactic and semantic analysis, including
extraction of sentiments using a sentiment lexicon constructed upon a semantic hierarchy.

2. The method of claim 1, further including the step of determining the sign of the extracted sentiments.

3. The method of claim 1, further including the step of determining the aggregate function of text data.

4. The method of claim 1, further including the step of identifying social networks based on the extracted entities and facts.

5. The method of claim 1, further including the step of identifying topics based on the extracted entities and facts.

6. The method of claim 1, further including the step of analyzing the social mood based on the extracted sentiments.

7. The method of claim 1, further including the step of classifying text data based on the extracted sentiments.

8. A system of text data analysis, including:
one or more processors adjusted for:
obtaining text data;
performing deep syntactic and semantic analysis of text data;
extracting entities and facts from text data based on the results of deep syntactic and semantic analysis, including
extraction of sentiments using a sentiment lexicon constructed upon a semantic hierarchy.

9. The system of claim 7, further including the step of determining the sign of the extracted sentiments.

10. The system of claim 7, further including the step of determining the aggregate function of text data.

11. The system of claim 7, further including the step of identifying social networks based on the extracted entities and facts.

12. The system of claim 7, further including the step of identifying topics based on the extracted entities and facts.

13. The system of claim 7, further including the step of analyzing the social mood based on the extracted sentiments.

14. The system of claim 7, further including the step of classifying text data based on the extracted sentiments.

15. A non-volatile machine-readable information storage medium containing the following instructions:
obtaining text data;
performing deep syntactic and semantic analysis of text data;
extracting entities and facts from text data based on the results of deep syntactic and semantic analysis, including
extraction of sentiments using a sentiment lexicon constructed upon a semantic hierarchy.

16. The non-volatile machine-readable information storage medium of claim 13, further including the step of determining the sign of the extracted sentiments.

17. The non-volatile machine-readable information storage medium of claim 13, further including the step of determining the aggregate function of text data.

18. The non-volatile machine-readable information storage medium of claim 13, further including the step of identifying social networks based on the extracted entities and facts.

19. The non-volatile machine-readable information storage medium of claim 13, further including the step of identifying topics based on the extracted entities and facts.

20. The non-volatile machine-readable information storage medium of claim 13, further including the step of analyzing the social mood based on the extracted sentiments.

21. The non-volatile machine-readable information storage medium of claim 13, further including the step of classifying text data based on the extracted sentiments.
